(19) United States
(12) Patent Application Publication
(10) Pub. No.: US 2024/0104080 A1
(43) Pub. Date: Mar. 28, 2024

(54) INFORMATION TRANSACTION SYSTEM, INFORMATION TRANSACTION DEVICE, INFORMATION TRANSACTION METHOD, AND PROGRAM

(71) Applicant: NEC Corporation, Minato-ku, Tokyo (JP)

(72) Inventors: Yusuke SATO, Minato-ku, Tokyo (JP); Yasumasa Mitsuhata, Minato-ku, Tokyo (JP); Masashi Inoue, Tokyo (JP); Yurika Michishita, Tokyo (JP)

(73) Assignee: NEC Corporation, Minato-ku, Tokyo (JP)

(21) Appl. No.: 17/768,603

(22) PCT Filed: Oct. 7, 2020
(86) PCT No.: PCT/JP2020/037969

§ 371 Date: Apr. 13, 2022

(30) Foreign Application Priority Data
Oct. 31, 2019 (JP) 2019-199142
Feb. 25, 2020 (JP) 2020-029851

(51) Int. Cl. G06F 16/22

(52) U.S. Cl. CPC G06F 16/2291

(57) ABSTRACT

An information transaction device stores catalog information including detailed information related to one or more datasets including personal information providable to an information provision destination device from an information provision source device. The information transaction device receives a provision request for the dataset from the information provision destination device. The information transaction device outputs a transmission request for the dataset indicated by the provision request to the information provision source device.

### TECHNICAL FIELD

The present invention relates to an information transaction system, an information transaction device, an information transaction method, and a program.

### BACKGROUND ART

A computer system that provides personal information held in a hospital or the like to a device of an information provision destination such as an application operator desiring to apply the personal information based on personal content has been suggested. Such a computer system communicably connects an information provision source device and an information provision destination device to an information transaction device managed by an organization such as an information bank. The information provision source device is a device managed by an organization such as a company of an information provision source. The information provision destination device is a device managed by an organization of the information provision destination such as the application operator. The information transaction device stores personal information transmitted from the information provision source device and, from the personal information, transmits personal information desired by the application operator or the like managing the information provision destination device to the information provision destination device. Technologies related to such a system are disclosed in Patent Document 1 and Patent Document 2.

Patent Document 1 discloses a technology for, when a request for personal information is made from the application operator for personal information held by a holding operator or the like, causing a mediation server to publish a combination of attributes of an information provider and information about the information provider that are not allowed to be published, to a user terminal by replacing names with dummy information so that the names cannot be identified. This technology causes the personal information to be safely published to the outside.

Patent Document 2 discloses a technology for acquiring medical data without passing through an external network, correcting the medical data based on a correction instruction, and outputting the corrected medical data to the network. This technology enables a fluid change in protection range of personal information included in the medical data and causes the medical data to be safely distributed to the external network.

### PRIOR ART DOCUMENTS

### Patent Documents

### Patent Document 1

Japanese Unexamined Patent Application, First Publication No. 2007-264730

### Patent Document 2

Japanese Unexamined Patent Application, First Publication No. 2019-96134

### SUMMARY OF INVENTION

### Problems to be Solved by the Invention

In the above computer system, personal information generated by a plurality of information provision sources is stored in the information transaction device that is disposed outside information provision source devices managing the information provision sources and mediates provision of the personal information to the information provision destination device. In such a computer system, the information transaction device holds a large amount of personal information generated by a plurality of information provision source devices or the like. In such a case, particularly, in a case where a large number of information provision source devices are present, a concentrated risk of improper leakage or the like of a large amount of personal information generated by an organization managing the information provision source devices occurs in the information transaction device.

An object of the present invention is to provide an information transaction system, an information transaction device, an information transaction method, and a program that solve the above problem.

### Means for Solving the Problems

According to a first aspect of the present invention, an information transaction system includes an information provision source device, and an information transaction device communicably connected to an information provision destination device, in which the information transaction device stores catalog information including detailed information related to one or more datasets including personal information providable to the information provision destination device from the information provision source device, receives a provision request for the dataset from the information provision destination device, and outputs a transmission request for the dataset indicated by the provision request to the information provision source device.

According to a second aspect of the present invention, an information transaction device is configured to store catalog information including detailed information related to one or more datasets including personal information providable to an information provision destination device from an information provision source device, receive a provision request for the dataset from the information provision destination device, and output a transmission request for the dataset indicated by the provision request to the information provision source device.

According to a third aspect of the present invention, an information transaction method in an information transaction system including an information transaction device connected to an information provision source device and an information provision destination device includes, by the information transaction device, storing catalog information including detailed information related to one or more datasets including personal information providable to the information provision destination device from the information provision source device, receiving a provision request for the dataset from the information provision destination device, and outputting a transmission request for the dataset indicated by the provision request to the information provision source device.

According to a fourth aspect of the present invention, a program causes a computer of an information transaction device to function as means for storing catalog information including detailed information related to one or more datasets including personal information providable to an information provision destination device from an information provision source device, means for receiving a provision request for the dataset from the information provision destination device, and means for outputting a transmission request for the dataset indicated by the provision request to the information provision source device.

According to a fifth aspect of the present invention, an information transaction method includes transmitting, to an information provision destination device, a dataset designation web page on which description items related to one or more datasets including personal information providable to the information provision destination device from an information provision source device are described for each dataset, receiving a selection of a dataset of a provision request target among the one or more datasets described on the dataset designation web page from the information provision destination device, and outputting, in a case where approval of provision of personal information included in the dataset of the provision request target is received, a transmission request for the personal information with respect to the information provision destination device to the information provision source device storing the personal information.

According to a sixth aspect of the present invention, an information transaction device is configured to transmit, to an information provision destination device, a dataset designation web page on which description items related to one or more datasets including personal information providable to the information provision destination device from an information provision source device are described for each dataset, receive a selection of a dataset of a provision request target among the one or more datasets described on the dataset designation web page from the information provision destination device, and in a case where approval of provision of personal information included in the dataset of the provision request target is received, output a transmission request for the personal information with respect to the information provision destination device to the information provision source device storing the personal information.

According to a seventh aspect of the present invention, a program recorded on a recording medium causes a computer of an information transaction device to function as means for transmitting, to an information provision destination device, a dataset designation web page on which description items related to one or more datasets including personal information providable to the information provision destination device from an information provision source device are described for each dataset, means for receiving a selection of a dataset of a provision request target among the one or more datasets described on the dataset designation web page from the information provision destination device, and means for, in a case where approval of provision of personal information included in the dataset of the provision request target is received, outputting a transmission request for the personal information with respect to the information provision destination device to the information provision source device storing the personal information.

### Advantageous Effects of the Invention

According to the present invention, an information transaction system, an information transaction device, an information transaction method, and a program that manage personal information without concentrating a risk such as improper leakage of a large amount of personal information generated by each of a plurality of information provision sources managing an information provision source device in the information transaction device can be provided.

### BRIEF DESCRIPTION OF DRAWINGS

FIG. 1 is a block diagram showing a configuration of an information transaction system according to a first embodiment.

FIG. 2 is a block diagram showing hardware of an information transaction device in the information transaction system of the first embodiment.

FIG. 3 is a block diagram showing functions of the information transaction device in the information transaction system of the first embodiment.

FIG. 4 is a diagram showing an example of various information included in catalog information generated by a catalog information generation unit of the information transaction device shown in FIG. 3.

FIG. 5 is a diagram showing information indicating locations of personal data supplied in the information transaction system according to the first embodiment.

FIG. 6 is a first flowchart showing a process performed between the information transaction device and an information provision destination device in the information transaction system according to the first embodiment.

FIG. 7 is a second flowchart showing a process performed between the information transaction device and an information provision source device in the information transaction system according to the first embodiment.

FIG. 8 is a third flowchart showing a process performed among the information transaction device, the information provision destination device, a personal terminal, and the information provision source device in the information transaction system according to the first embodiment.

FIG. 9 is a block diagram showing functions of an information transaction device according to a second embodiment.

FIG. 10 is a flowchart showing a process of an information transaction system including the information transaction device according to the second embodiment.

FIG. 11 is a block diagram showing a configuration of an information transaction system according to a third embodiment.

FIG. 12 is a block diagram showing an information transaction device of a minimum configuration included in the first to third embodiments.

FIG. 13 is a flowchart showing a process performed by the information transaction device of the minimum configuration included in the first to third embodiments.

FIG. 14 is a block diagram showing functions of an information transaction device according to a fourth embodiment.

FIG. 15 is a diagram showing an example of catalog information included in a web page for designating a dataset in an information transaction system including the information transaction device according to the fourth embodiment.

FIG. 16 is a diagram showing information indicating locations of personal data supplied in the information transaction system including the information transaction device according to the fourth embodiment.

FIG. 17 is a first flowchart showing a process performed between the information transaction device and the information provision destination device in the information transaction system including the information transaction device according to the fourth embodiment.

FIG. 18 is a second flowchart showing a process performed between the information transaction device and the information provision source device in the information transaction system including the information transaction device according to the fourth embodiment.

FIG. 19 is a third flowchart showing a process performed between the information transaction device, the information provision destination device, the personal terminal, and the information provision source device in the information transaction system including the information transaction device according to the fourth embodiment.

FIG. 20 is a block diagram showing functions of an information transaction device according to a fifth embodiment.

FIG. 21 is a flowchart showing a process of an information transaction system including the information transaction device according to the fifth embodiment.

FIG. 22 is a block diagram showing a configuration of an information transaction system according to a sixth embodiment.

FIG. 23 is a block diagram showing an information transaction device of a minimum configuration included in the fourth to sixth embodiments.

FIG. 24 is a flowchart showing a process performed by the information transaction device of the minimum configuration included in the fourth to sixth embodiments.

### EXAMPLE EMBODIMENTS

### First Embodiment

Hereinafter, an information transaction system including an information transaction device according to a first embodiment of the present invention will be described with reference to the drawings.

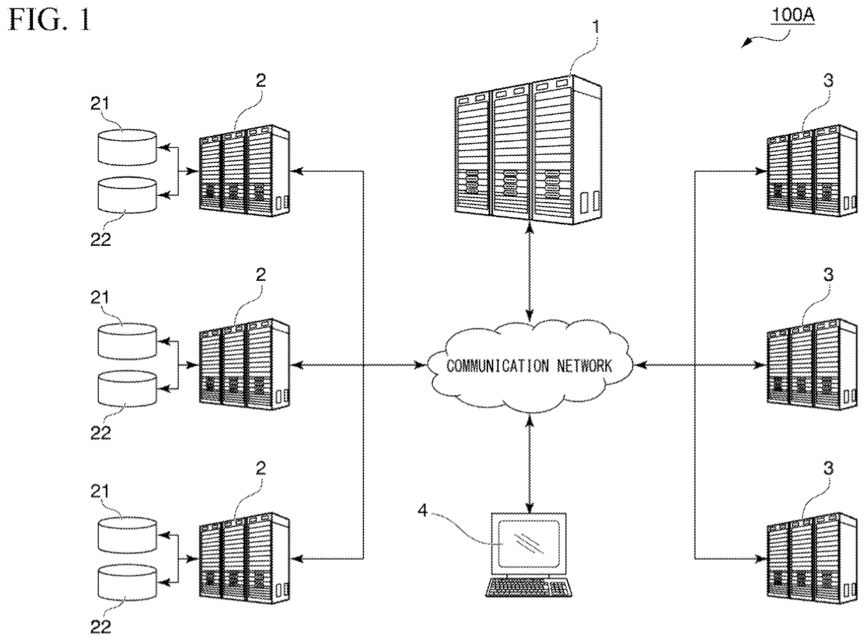

FIG. 1 is a first diagram showing a configuration of an information transaction system according to the first embodiment.

An information transaction system 100A is configured by communicably connecting an information transaction device 1, an information provision source device 2, and an information provision destination device 3.

The information provision source device 2 is a computer device that manages personal information generated by an organization or the like of an information provision source. For example, the organization of the information provision source may be a hospital or a company. The information transaction device 1 may be communicably connected to a plurality of information provision source devices 2 managed by a plurality of organizations of different information provision sources. The information provision source device 2 may be directly communicably connected to the information provision destination device 3.

The information provision destination device 3 is a computer device that performs various information processes by applying the personal information provided from the information provision source device 2. For example, an organization of an information provision destination may be a company or a public organization. The information transaction device 1 may be communicably connected to a plurality of information provision destination devices 3 managed by a plurality of organizations of different information provision destinations.

The information provision source device 2 includes a first database 21 (hereinafter, referred to as the first DB 21) and a second database 22 (hereinafter, referred to as the second DB 22). The first DB 21 is a storage device that stores the personal information generated by the information provision source. The second DB 22 stores a dataset that is generated based on the personal information stored in the first DB 21 and includes the personal information. The information provision source device 2 transmits a dataset indicated by a transmission request acquired from the information transaction device 1 to the information provision destination device 3 based on the transmission request.

A personal terminal 4 is communicably connected to the information transaction device 1. The personal terminal 4 is a computer device used by a personal user who is a target of an acquisition source of the personal information generated by the organization of the information provision source. The personal user approves provision of the personal information generated by the organization of the information provision source as information about the personal user to the information provision destination device 3, and registers the approval result in the information transaction device 1 using the personal terminal 4.

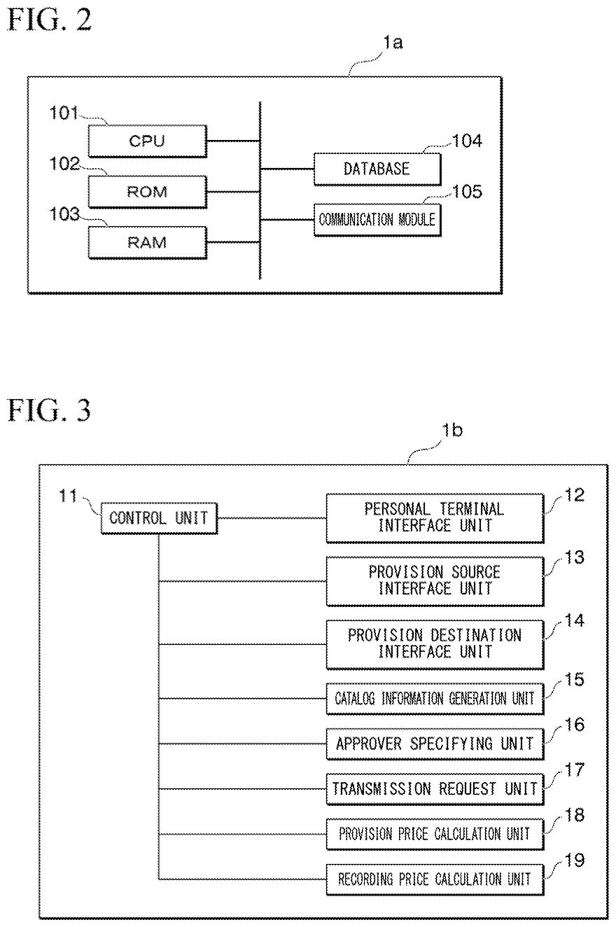

FIG. 2 is a hardware configuration diagram of the information transaction device in the information transaction system of the first embodiment.

As shown in FIG. 2, an information transaction device 1a is a computer device including various hardware such as a central processing unit (CPU) 101, a read only memory (ROM) 102, a random-access memory (RAM) 103, a database 104, and a communication module 105. The information provision source device 2, the information provision destination device 3, and the personal terminal 4 are also computer devices having the same hardware configuration.

FIG. 3 is a function block diagram of the information transaction device in the information transaction system according to the first embodiment.

An information transaction device 1b starts an information transaction management program in advance. Accordingly, the information transaction device 1b has configurations of a control unit 11, a personal terminal interface unit 12, a provision source interface unit 13, a provision destination interface unit 14, a catalog information generation unit 15, an approver specifying unit 16, a transmission request unit 17, a provision price calculation unit 18, and a recording price calculation unit 19.

The control unit 11 controls each function unit of the information transaction device 1b.

The personal terminal interface unit 12 processes output of information to the personal terminal 4 and acquisition of information transmitted from the personal terminal 4.

The provision source interface unit 13 processes output of information to the information provision source device 2 and acquisition of information transmitted from the information provision source device 2.

The provision destination interface unit 14 processes output of information to the information provision destination device 3 and acquisition of information transmitted from the information provision destination device 3.

The catalog information generation unit 15 generates catalog information. The catalog information is information indicating detailed information related to one or more datasets including personal information providable to the information provision destination device from the information provision source device. Details of the catalog information will be described later.

The approver specifying unit 16 specifies a personal user of an approver of provision of the dataset based on a provision request for the dataset transmitted by the information provision destination device 3.

The transmission request unit 17 outputs the transmission request for the dataset indicated by the provision request to the information provision source device 2.

The provision price calculation unit 18 calculates a provision price based on an information amount of the personal information transmitted to the information provision destination device 3 from the information provision source device 2. For example, the provision price indicates the amount of provision price paid to the personal user.

The recording price calculation unit 19 calculates a recording price based on an information amount recorded in a storage device of the information provision source device 2 as the personal information transmitted to the information provision destination device 3 by the information provision source device 2. For example, the recording price indicates the amount of recording price paid to the personal user.

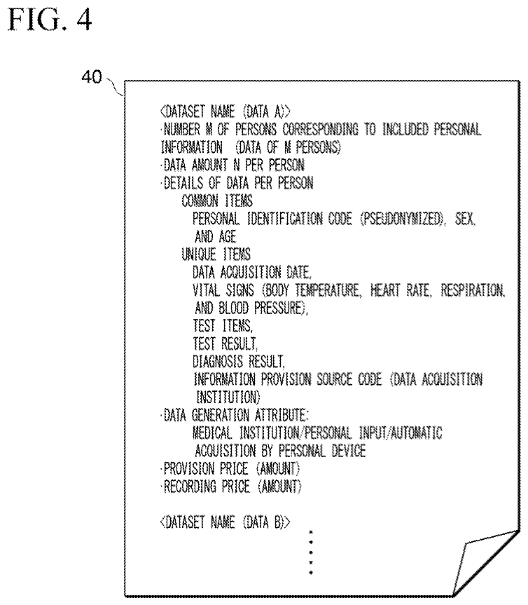

FIG. 4 is a diagram showing details of the catalog information generated by the catalog information generation unit 15 of the information transaction device.

For example, catalog information 40 includes information such as a dataset name related to the dataset, a number M of persons corresponding to the personal information included in the dataset, a data amount N per person, details of data (personal information) per person, a data generation attribute, the provision price, and the recording price. For example, in a case where the provision source is a hospital, details of the data per person include common items (a personal identification code, a sex, and an age) and unique items (a data acquisition date, vital signs (a body temperature, a heart rate, respiration, and a blood pressure), test items, a test result, a diagnosis result, and an information provision source code). The information provision source code is identification information related to the organization of the information provision source managing the information provision source device. In addition, the data generation attribute includes identification information of a generation source of the personal information indicating whether the personal information is information registered by a medical institution (medical institution), information input by a person (personal input), or information automatically acquired from a device such as a sensor (automatic acquisition by a personal device). A responsible person of the organization of the information provision destination who uses the information provision destination device 3 selects a dataset desired to be provided by checking the detailed information related to the dataset included in the catalog information.

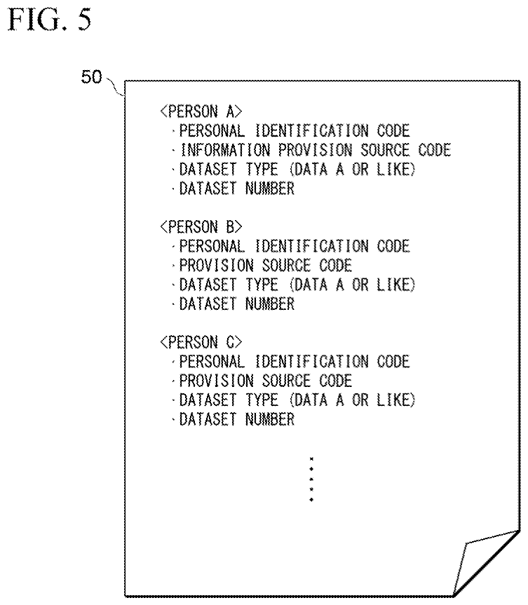

FIG. 5 is a diagram showing details of personal data location information supplied in the information transaction system according to the first embodiment.

Personal data location information 50 stores a personal identification code, the information provision source code, a dataset type, a dataset number, and the like for each person. The personal identification code is a code for identifying the personal user who provides the personal information. The information provision source code is identification information of the organization that manages the information provision source device 2 storing the dataset including the personal information of the person indicated by the personal identification code. The dataset type is a type or an identifier of the dataset including the personal information of the person indicated by the personal identification code. The dataset number is the number of datasets including the personal information of the person indicated by the personal identification code. Based on the personal data location information, the information transaction device 1b specifies the information provision source device 2 storing the dataset indicated by the provision request acquired from the information provision destination device 3.

The information transaction system 100A according to the present embodiment includes the information transaction device 1b connected to the information provision source device 2 and the information provision destination device 3. The information transaction device 1b stores the catalog information including the detailed information related to one or more datasets including the personal information providable to the information provision destination device 3 from the information provision source device 2, and receives the provision request for the dataset from the information provision destination device 3. The information transaction device 1b outputs the transmission request for the dataset indicated by the provision request to the information provision source device 2.

Accordingly, the personal information stored in the information provision source device 2 managed by each of the plurality of organizations of the information provision sources does not need to be stored in the information transaction device 1b. Thus, the personal information can be managed without concentrating a risk such as improper leakage of a large amount of personal information generated by each of the plurality of information provision sources managing the information provision source device 2 in the information transaction device 1b.

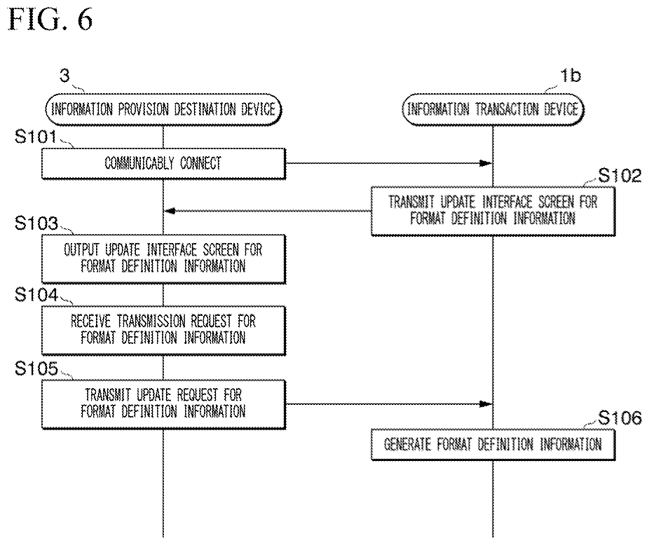

FIG. 6 shows a process flow performed between the information transaction device and the information provision destination device in the information transaction system according to the first embodiment.

The information transaction device 1b further stores format definition information in which a format type of the dataset is defined. The information provision source device 2 or the information provision destination device 3 can request the information transaction device 1b to generate the format definition information related to a dataset that includes new personal information and for which the format definition information stored in the information transaction device 1b is not defined yet.

In a case where the responsible person of the organization of the information provision destination desires to receive provision of a new dataset, the responsible person connects the information provision destination device 3 to the information transaction device 1b. Accordingly, the information provision destination device 3 and the information transaction device 1b are connected and perform communication (step S101). The provision destination interface unit 14 of the information transaction device 1b has a function of an application programming interface (API) for updating the format definition information and transmits an update interface screen for the format definition information to the connected information provision destination device 3 (step S102). The information provision destination device 3 acquires the update interface screen and outputs the update interface screen for the format definition information to a display (step S103). The responsible person of the organization of the information provision destination inputs a format type of the personal information newly included in the dataset in an input field of the update interface screen for the format definition information and inputs the transmission request. The information provision destination device 3 receives the transmission request (step S104). The information provision destination device 3 transmits an update request for the format definition information including the format type of the personal information newly included in the dataset to the information transaction device 1b (step S105). This process is an aspect of a process of transmitting a request for adding new personal information other than personal information includable in the dataset indicated by the format definition information to the dataset, by the information provision destination device 3.

The provision destination interface unit 14 of the information transaction device 1b acquires the update request for the format definition information. The provision destination interface unit 14 acquires the format type of the personal information newly included in the dataset from the update request for the format definition information and outputs the format type to the control unit 11. The control unit 11 generates the format definition information in which the format type of the dataset is defined, and records the format definition information in a storage unit of the information transaction device 1b (step S106). By the above process, the information provision source device 2 can generate the dataset that includes the new personal information and for which the format definition information is not defined yet, using the format definition information in which the format type of the dataset is defined.

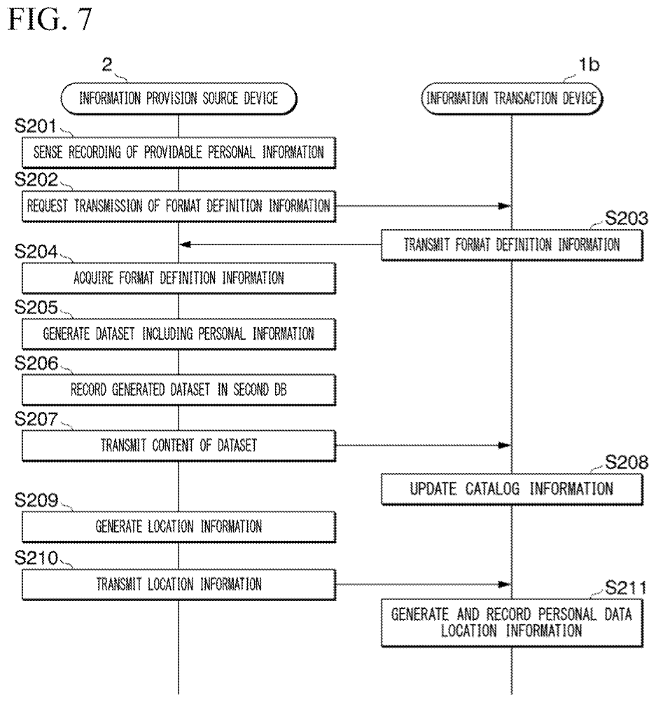

FIG. 7 shows a process flow performed between the information transaction device and the information provision source device in the information transaction system according to the first embodiment.

The information provision source device 2 senses recording of providable personal information in the first DB 21 in generating the dataset including the personal information (step S201). The personal information may be data including personal information generated by a computer of the organization of the information provision source connected to the information provision source device 2 or may be data including personal information automatically generated by a device such as a sensor. Alternatively, the dataset may be data including personal information that is input into a computer or the like belonging to the organization of the information provision source by the personal user, or may be data including personal information that is transmitted to the computer belonging to the organization of the information provision source by the personal user using the personal terminal 4.

The personal information may be information such as the common items (the personal identification code, the sex, and the age of the person associated with the personal information included as the dataset), the unique items (the data acquisition date, a data content, and identification information of the information provision source of the personal information included as the dataset), and the data generation attribute (the organization, the person, or the device that generates or inputs the personal information) of the catalog information. For example, in a case where the organization of the information provision source is a hospital, and a doctor of the hospital examines the personal user, the personal information included in the dataset generated in the hospital includes the personal identification code for identifying the person, the sex, the age, the data acquisition date, the vital signs (the body temperature, the heart rate, the respiration, and the blood pressure), the test items in examination, the test result, and the diagnosis result.

The information provision source device 2 reads the personal information from the first DB 21. In generating the dataset including the personal information, the information provision source device 2 communicably connects to the information transaction device 1b and requests transmission of the format definition information (step S202). The provision source interface unit 13 of the information transaction device 1b receives a designation of the personal information and transmits the format definition information corresponding to the personal information to the information provision source device 2 (step S203).

The information provision source device 2 acquires the format definition information (step S204). The information provision source device 2 generates a dataset including the personal information in accordance with a data type indicated by the format definition information (step S205). The information provision source device 2 records the generated dataset in the second DB 22 (step S206).

Accordingly, the information provision source device 2 stores the dataset holding the personal information in accordance with the data type indicated by the format definition information. The plurality of information provision source devices 2 generate datasets of the data type indicated by the format definition information in the same manner. Accordingly, the information provision destination device 3 that receives provision of the datasets can acquire uniform datasets of the same data type transmitted from each information provision source device 2. Thus, the information provision destination device 3 can easily perform a process using the personal information included in the datasets.

The information provision source device 2 transmits information about a content related to the generated dataset to the information transaction device 1b (step S207). The information about the content related to the dataset includes information such as the dataset name related to the dataset, the number M of persons corresponding to the personal information included in the dataset, the data amount N per person, the details of data (personal information) per person, the data generation attribute, the provision price, and the recording price. For example, in a case where the provision source is a hospital, the details of the data per person include the common items (the personal identification code, the sex, and the age) and the unique items (the data acquisition date, the vital signs (the body temperature, the heart rate, the respiration, and the blood pressure), the test items, the test result, the diagnosis result, and the information provision source code). The catalog information generation unit of the information transaction device 1b generates catalog information including the information about the content related to the generated dataset and updates the already stored catalog information (step S208).

Based on the generated dataset, the information provision source device 2 generates location information including the personal identification code of the person corresponding to the personal information included in the dataset, the information provision source code indicating the organization of the information provision source generating the dataset, the dataset type, the dataset number, and the like (step S209). The information provision source device 2 transmits the location information to the information transaction device 1b (step S210).

The provision source interface unit 13 of the information transaction device 1b acquires the location information transmitted from the information provision source device 2. The provision source interface unit 13 generates the personal data location information 50 including the new location information and records the personal data location information 50 in the database 104 of the information transaction device 1b (step S211). Accordingly, the information transaction device 1b can perceive which information provision source device 2 holds which dataset.

The recording price calculation unit 19 may calculate the amount of recording price provided to the personal user corresponding to the personal information included in the dataset for recording of the dataset in the second DB 22. In this case, for example, the recording price calculation unit 19 specifies the dataset name recorded in the second DB 22. The recording price calculation unit 19 acquires the amount of recording price per unit amount of the dataset from the information transaction device 1b. The recording price calculation unit 19 calculates the amount of recording price of the dataset recorded in the second DB 22 based on the amount of recording price per unit amount of the dataset and transmits the calculated amount of recording price to the information transaction device 1b. The information transaction device 1b stores information about the amount of recording price of the dataset for each personal user. Based on a request from the personal terminal, the information transaction device 1b transmits the amount of recording price of the dataset stored for the personal user operating the personal terminal to the personal terminal 4. Accordingly, the personal user can check the price in a case where the personal information of the personal user is recorded in the information provision source device 2 as a provision candidate. The amount of recording price provided to the personal user may be calculated for each predetermined period.

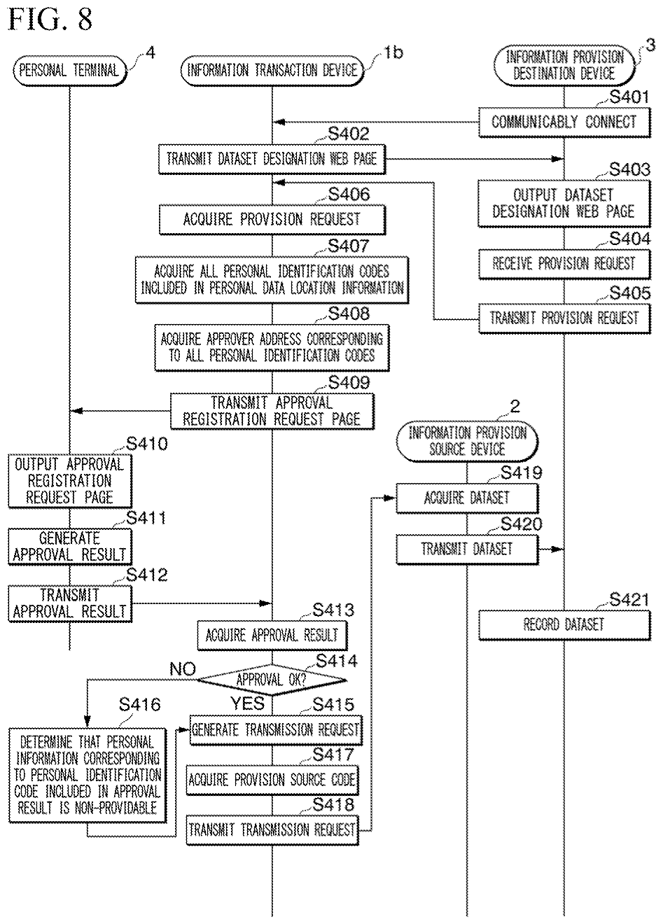

FIG. 8 shows a process flow performed among the information transaction device, the information provision destination device, the personal terminal, and the information provision source device in the information transaction system according to the first embodiment.

In a case where a manager of the information provision destination such as a data application organization managing the information provision destination device 3 desires to receive provision of the dataset, the manager communicably connects the information provision destination device 3 to the information transaction device 1b. Accordingly, the information transaction device 1b and the information provision destination device 3 are communicably connected (step S401). The provision destination interface unit 14 of the information transaction device 1b transmits a dataset designation web page for receiving a designation of the dataset of a provision target to the connected information provision destination device 3 (step S402). The dataset designation web page is information generated based on detailed information related to each dataset included in the catalog information and displays details of each dataset and a list of datasets. Accordingly, by causing the information provision destination device 3 to output the dataset designation web page, the manager of the organization of the information provision destination can check a list of dataset names providable by the information provision source published in the catalog information as a catalog.

The information provision destination device 3 acquires the dataset designation web page and outputs the dataset designation web page to the display (step S403). The responsible person of the organization of the information provision destination checks a check field of a dataset desired to be provided among check fields displayed in association with information related to each dataset of the dataset designation web page, and presses a provision request button. The information provision destination device 3 receives the provision request (step S404). The information provision destination device 3 transmits a provision request including one or a plurality of dataset names received as the provision request to the information transaction device 1b (step S405). In addition to the dataset name, the provision request may include information such as an ID of the information provision destination device 3 and a network address of the information provision destination device 3.

The provision destination interface unit 14 of the information transaction device 1b acquires the provision request (step S406). The provision destination interface unit 14 outputs the provision request to the approver specifying unit 16. The approver specifying unit 16 acquires the provision request. The approver specifying unit 16 acquires the dataset name included in the provision request. The approver specifying unit 16 acquires all personal identification codes included in the personal data location information 50 in association with the dataset name (step S407). The approver specifying unit 16 acquires an approver address that is stored in advance in the information transaction device 1b in association with all personal identification codes (step S408). The approver address is an address of the personal terminal 4. Alternatively, the approver address may be an address held by an application program held by the personal terminal 4. The approver specifying unit 16 transmits an approval registration request page to each personal terminal 4 specified by the approver address (step S409). The approval registration request page includes information such as the dataset name included in the provision request and an organization name of the organization of the information provision destination managing the information provision destination device 3 that has transmitted the provision request.

Each personal terminal 4 acquires the approval registration request page. The personal terminal 4 outputs the approval registration request page to a display (step S410). The approval registration request page may include the amount of provision price or recording price in association with the dataset name, and the approval registration request page including this information may be output to the display of the personal terminal 4. The personal user recognizes the dataset name, the organization name of the organization of the information provision destination, and the provision price or the recording price displayed on the approval registration request page and provides an approval input indicating whether or not the personal information specified by the dataset name may be provided to the organization of the information provision destination. For example, buttons of approval OK and approval NG are further displayed on the approval registration request page. The user can provide the approval input indicating any of approval OK or approval NG by pressing any button using an input device such as a mouse. In a case where the user performs a press operation on the button of approval OK, each personal terminal 4 generates an approval result including a flag of approval OK (step S411). In a case where the user performs a press operation on the button of approval NG, each personal terminal 4 generates an approval result including a flag of approval NG. The approval registration request page may further include the dataset name, the organization name of the organization of the information provision destination, the personal identification code of the personal user using the personal terminal 4, and the like included in the approval request. Each personal terminal 4 transmits the generated approval result to the information transaction device 1b (step S412).

The personal terminal interface unit 12 of the information transaction device 1b acquires the approval result received from each personal terminal 4 (step S413). The personal terminal interface unit 12 outputs the approval result to the transmission request unit 17. The transmission request unit 17 determines whether or not the flag of approval OK is included in each approval result (step S414). In a case where the flag of approval OK is included in each approval result, the transmission request unit 17 generates the transmission request (step S415). The transmission request may include the dataset name, the organization name of the organization of the information provision destination, the ID of the information provision destination device 3, the network address of the information provision destination device 3, and the like included in the approval result. In a case where the flag of approval NG is included in each approval result, the transmission request unit 17 acquires the personal identification code included in the approval result and determines that the personal information corresponding to the personal identification code is non-providable (step S416).

The transmission request unit 17 acquires the information provision source code for identifying one or each of the plurality of information provision source devices 2 included in the catalog information 40 in association with the dataset name (step S417). The transmission request unit 17 stores a network address of the information provision source device 2 in advance in association with the information provision source code. The transmission request unit 17 acquires the stored network address of the information provision source device 2 in association with the acquired information provision source code. The transmission request unit 17 transmits the transmission request to the acquired network address (step S418). In the transmission request, the personal identification code included in the approval result indicating approval NG in step S416 is stored as the personal identification code of the personal user corresponding to the non-providable personal information.

The information provision source device 2 receives the transmission request. The information provision source device 2 acquires the dataset name, the organization name of the organization of the provision destination, the ID of the information provision destination device 3, the network address of the information provision destination device 3, and the personal identification code of the personal user corresponding to the non-providable personal information included in the transmission request. The information provision source device 2 acquires the dataset corresponding to the dataset name from the second DB 22 (step S419). The information provision source device 2 deletes the personal information corresponding to the personal identification code stored in the transmission request from the personal information included in the dataset. The information provision source device 2 transmits the dataset to the network address of the information provision destination device 3 included in the transmission request (step S420). The information provision destination device 3 receives the dataset. The information provision destination device 3 records the received dataset in a database or the like included in the information provision destination device 3 (step S421). Then, the information provision destination device 3 performs a predetermined process using the received dataset. The information provision source device 2 may transmit the dataset transmitted in accordance with the transmission request to the information provision destination device 3 through the information transaction device 1b. In a case of transferring to one information provision destination device 3, the information provision source device 2 may collectively transfer datasets acquired from a plurality of different information provision source devices 2.

According to the above process, the information transaction device 1b can control transmission of the dataset to the information provision destination device 3 desiring to receive provision without storing the dataset including the personal information generated by the plurality of information provision source devices 2 in the information transaction device 1b. Accordingly, a system for managing the personal information without concentrating a risk such as improper leakage of a large amount of personal information generated by each of the plurality of information provision sources managing the information provision source device 2 in the information transaction device 1b can be provided.

The provision price calculation unit 18 may calculate the amount of provision price provided to the personal user corresponding to the personal information included in the dataset for transmission of the dataset to the information provision destination device 3 from the information provision source device 2. In this case, for example, the provision price calculation unit 18 acquires information related to transmission of the dataset based on the transmission request from the information provision source device 2 and specifies the dataset name transmitted to the information provision destination device 3 by the information provision source device 2. The provision price calculation unit 18 acquires the amount of provision price per unit amount of the dataset from the information transaction device 1b. The provision price calculation unit 18 calculates the amount of provision price of the dataset transmitted to the information provision destination device 3 based on the amount of provision price per unit amount of the dataset and transmits the calculated amount of provision price to the information transaction device 1b. The information transaction device 1b stores information about the amount of provision price of the dataset for each personal user. Based on a request from the personal terminal, the information transaction device 1b transmits the amount of provision price of the dataset stored for the personal user operating the personal terminal to the personal terminal 4. Accordingly, the personal user can check the price for provision of the personal information of the personal user to the information provision destination device 3. The amount of provision price provided to the personal user may be calculated for each predetermined period.

### Second Embodiment

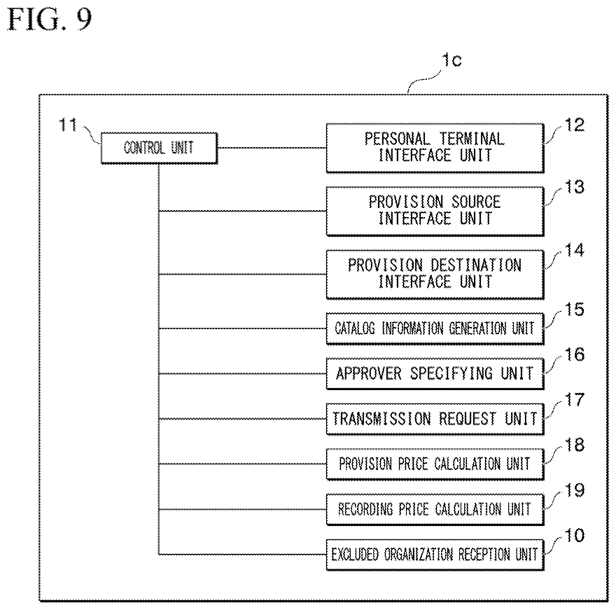

FIG. 9 is a function block diagram of an information transaction device according to a second embodiment.

An information transaction device 1c according to the second embodiment is different from the functions of the information transaction device 1b according to the first embodiment, in that a function of an excluded organization reception unit 10 is further exhibited.

The information transaction device 1c according to the second embodiment receives a selection of an organization of an exclusion target among organizations managing the information provision destination device 3 from the personal user. Based on the dataset indicated by the provision request transmitted by the information provision destination device 3, the information transaction device 1c acquires the personal identification code included in the personal data location information related to the dataset. In a case where the personal user selects the organization associated with the information provision destination device 3 that has transmitted the provision request as the organization of the exclusion target, the information transaction device 1c stops at least one of the approval request for provision of the personal information to the personal user or transmission of the dataset including the personal information to the information provision destination device 3. Hereinafter, details of a process of an information transaction system including the information transaction device 1c of the second embodiment will be described.

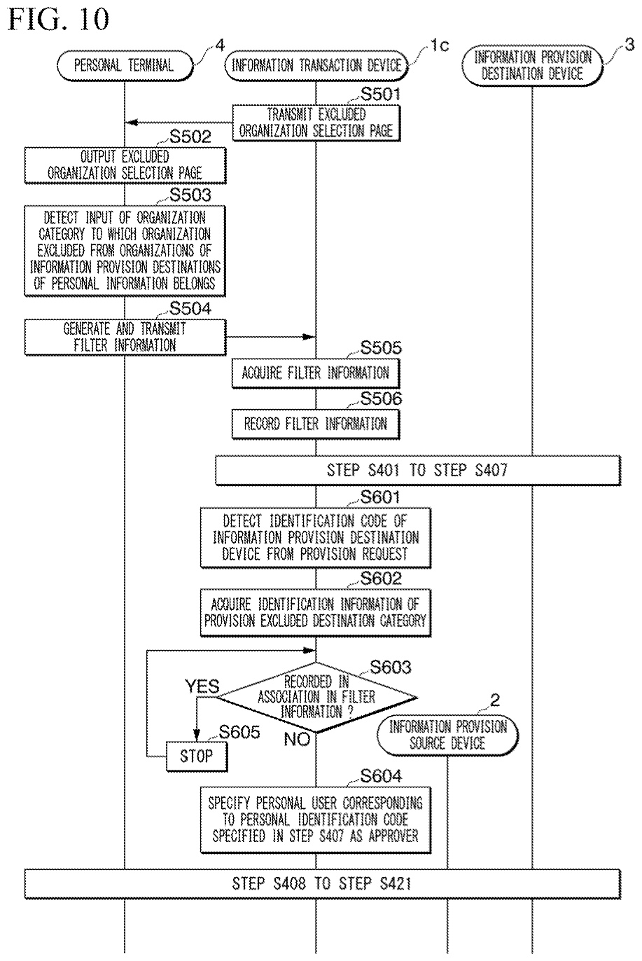

FIG. 10 shows a process flow of the information transaction system including the information transaction device according to the second embodiment.

In a process of receiving the selection of the organization excluded from the organizations as the information provision destinations of the dataset including the personal information of the personal user, the personal terminal interface unit 12 of the information transaction device 1c transmits an excluded organization selection page based on access from each personal terminal 4 (step S501). Each personal terminal 4 outputs the excluded organization selection page to the display (step S502). Each personal user selects the organization excluded from the provision destinations of the personal information on the excluded organization selection page displayed on the personal terminal 4. For example, a list of a plurality of organization categories to which candidates of the organization of the information provision destination of the personal information belong, and check buttons for designating exclusion of the organization categories are displayed on the excluded organization selection page. In addition, a registration button is displayed on the excluded organization selection page. Each personal user operates the check button of the organization category excluded from the organizations of the information provision destinations of the personal information to ON and performs a press operation on the registration button. Based on the operation, each personal terminal 4 detects an input of the organization category to which the organization excluded from the organizations of the information provision destinations of the personal information belongs (step S503). Each personal terminal 4 generates filter information including at least the personal identification code and the organization category to which the organization of the information provision destination of the exclusion target belongs, and transmits the filter information to the information transaction device 1c (step S504).

The personal terminal interface unit 12 of the information transaction device 1c acquires the filter information from each personal terminal 4 (step S505). The personal terminal interface unit 12 records each filter information in the storage unit such as the database 104 (step S506). The filter information is information in which the personal identification code and the organization category (provision excluded destination category) of the organization that is selected to be excluded from the organizations of the information provision destinations by the personal user indicated by the personal identification code are associated with each other.

By the above process among a plurality of personal terminals 4, the filter information related to a plurality of personal users is recorded in the information transaction device 1c. It is assumed that the information transaction device 1c stores, in advance, an organization table in which identification information of the organization category (provision excluded destination category), an identification code of the information provision source device 2 managing the organization belonging to the organization category, the network address of the information provision source device 2, and the like are held in association with each other.

In a state where the filter information and the organization table are stored as described above, processes of steps S401 to S405 of the first embodiment are performed, and the provision destination interface unit 14 of the information transaction device 1c acquires the provision request based on the process of step S405 (step S406). The provision destination interface unit 14 outputs the provision request to the approver specifying unit 16. The approver specifying unit 16 acquires the provision request. The approver specifying unit 16 acquires the dataset name included in the provision request. The approver specifying unit 16 acquires all personal identification codes included in the personal data location information 50 in association with the dataset name (step S407). The process up to here is the same as in the first embodiment.

The approver specifying unit 16 detects, from the provision request, an identification code of the information provision destination device 3 that has transmitted the provision request acquired in step S406 (step S601). The approver specifying unit 16 acquires the identification information of the provision excluded destination category recorded in the organization table in association with the information provision destination device 3 (step S602). The approver specifying unit 16 determines whether or not the personal user corresponding to the personal identification code specified in step S407 is excluded from the organizations of the information provision destinations. For example, the approver specifying unit 16 determines whether or not each personal identification code specified in step S407 and the identification information of the provision excluded destination category acquired in step S602 are recorded in the filter information in association with each other (step S603). In a case where the personal identification code specified in step S407 and the identification information of the provision excluded destination category acquired in step S602 are not recorded in the filter information in association with each other, the approver specifying unit 16 specifies the personal user corresponding to the personal identification code specified in step S407 as an approver (step S604). In a case where the personal identification code specified in step S407 and the identification information of the provision excluded destination category acquired in step S602 are recorded in the filter information in association with each other, the approver specifying unit 16 stops the approval request for each personal user of each personal identification code specified in step S407. Accordingly, the approver specifying unit 16 stops provision of the dataset including the personal information of the personal user (step S605).

The subsequent process is the same as the process from step S408 of the first embodiment. That is, the approver specifying unit 16 acquires the approver address stored in advance in the information transaction device 1c in association with the personal identification code specified in step S407 as the approver (step S408). The approver address is the address of the personal terminal 4. Alternatively, the approver address may be an address held by an application program held by the personal terminal 4. The approver specifying unit 16 transmits the approval registration request page to the personal terminal 4 specified by the approver address (step S409). Then, based on approval of the personal user, the processes of step S410 to step S421 are performed in the same manner as in the first embodiment. However, in a process corresponding to step S416 in the second embodiment, furthermore, the personal identification code of the personal user for which the approval request is stopped in step S605 is acquired, and it is determined that the personal information corresponding to the personal identification code is non-providable.

According to the above process, in a case where the information transaction device 1c receives the provision request of the organization excluded from the organizations of the information provision destinations of the personal information, the information transaction device 1c does not make the approval request for provision of the dataset (personal information) indicated by the provision request to the personal terminal 4. Accordingly, by causing the personal user to register the organization excluded from the organizations of the information provision destinations of the personal information in advance, a system of the information transaction system that does not receive an unnecessary approval request related to information provision can be provided.

### Third Embodiment

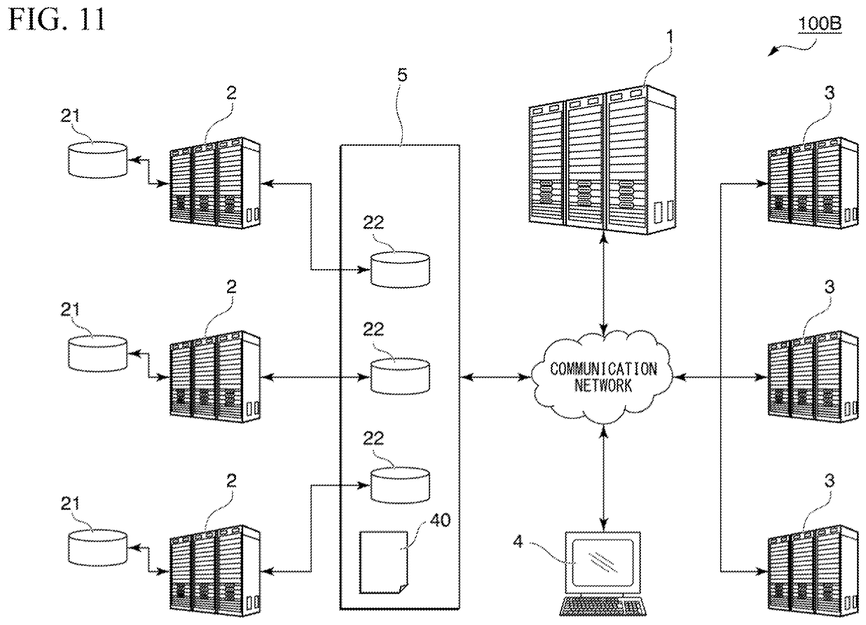

FIG. 11 is a diagram showing a configuration of an information transaction system according to a third embodiment.

An information transaction system 100B may have the configuration shown in FIG. 11. That is, in the information transaction system 100B, a data center 5 includes the second DB 22 included in the information provision source device 2 in the first embodiment. In addition, the data center 5 stores the catalog information 40 generated by the information transaction device 1. In a case where the information provision source device 2 generates the dataset, the information provision source device 2 registers the dataset in the second DB 22 included in the data center 5. In a case where the information transaction device 1 uses the catalog information 40, the information transaction device 1 may perform the process described in the other embodiments with reference to the catalog information 40 of the data center 5. Transmission of the dataset for which the information provision destination device 3 makes the provision request is performed by a processing unit of the data center 5 instead of the information provision source device 2 based on the transmission request of the transmission request unit 17 of the information transaction device 1. The data center 5 may store at least one of the dataset or the catalog information.

The embodiments of the present invention are described above. According to the process of each of the embodiments, an information transaction system in which a risk such as improper leakage of a large amount of personal information generated by each of the plurality of information provision sources managing the information provision source device 2 is not concentrated in the information transaction device 1 can be provided.

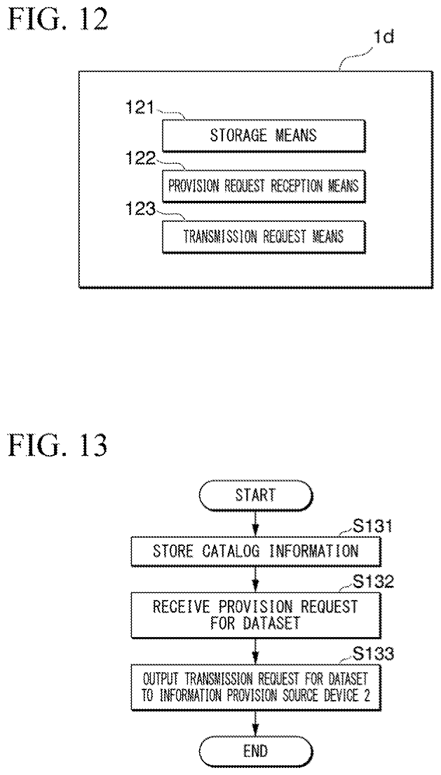

FIG. 12 is a diagram showing an information transaction device of a minimum configuration included in the first to third embodiments.

FIG. 13 is a diagram showing a process flow performed by the information transaction device of the minimum configuration included in the first to third embodiments.

An information transaction device 1d includes at least storage means 121, provision request reception means 122, and transmission request means 123.

The storage means stores the catalog information including the detailed information related to one or more datasets including the personal information providable to the information provision destination device 3 from the information provision source device 2 (step S131).

The provision request reception means receives the provision request for the dataset from the information provision destination device 3 (step S132).

The transmission request means outputs the transmission request for the dataset indicated by the provision request to the information provision source device 2 (step S133).

### Fourth Embodiment

Hereinafter, configurations of an information transaction device and an information transaction system embodying an information transaction method of the present invention will be described with reference to the drawings. An information transaction system including an information transaction device according to a fourth embodiment of the present invention is the same as in FIG. 1, and a hardware configuration of the information transaction device is the same as in FIG. 2.

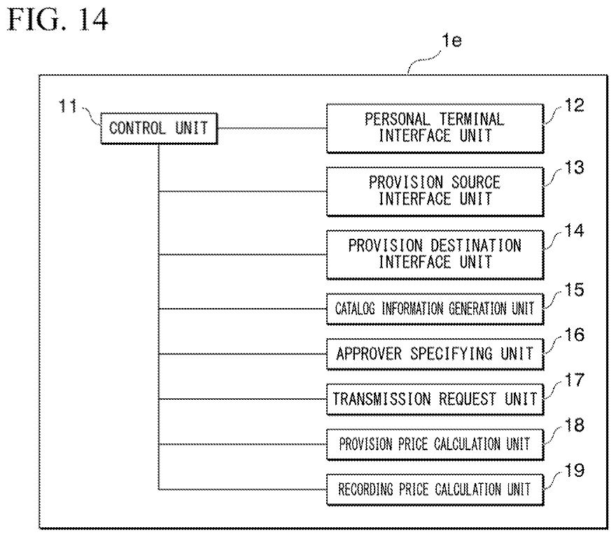

FIG. 14 is a function block diagram of the information transaction device according to the fourth embodiment.

An information transaction device 1e starts the information transaction management program in advance. Accordingly, the information transaction device 1e has the configurations of the control unit 11, the personal terminal interface unit 12, the provision source interface unit 13, the provision destination interface unit 14, the catalog information generation unit 15, the approver specifying unit 16, the transmission request unit 17, the provision price calculation unit 18, and the recording price calculation unit 19.

The control unit 11 controls each function unit of the information transaction device 1e.

The personal terminal interface unit 12 processes output of information to the personal terminal 4 and acquisition of information transmitted from the personal terminal 4.

The provision source interface unit 13 processes output of information to the information provision source device 2 and acquisition of information transmitted from the information provision source device 2.

The provision destination interface unit 14 processes output of information to the information provision destination device 3 and acquisition of information transmitted from the information provision destination device 3.

The catalog information generation unit 15 generates the catalog information 40. The catalog information 40 is information in which description items related to one or more datasets including the personal information providable to the information provision destination device from the information provision source device are defined for each dataset. One dataset includes one or more pieces of personal information that are personal information converted in accordance with different data types indicated by the format definition information for each personal information. In addition, the dataset is a provision unit of personal information including one or more pieces of personal information.

The approver specifying unit 16 specifies the personal user of the approver of provision of the dataset of a provision request target based on the provision request for the dataset transmitted by the information provision destination device 3.

The transmission request unit 17 outputs the transmission request for the dataset indicated by the provision request to the information provision source device 2.

The provision price calculation unit 18 calculates the provision price based on the information amount of the personal information transmitted to the information provision destination device 3 from the information provision source device 2. For example, the provision price indicates the amount of provision price paid to the personal user.

The recording price calculation unit 19 calculates the recording price based on the information amount recorded in the storage device of the information provision source device 2 as the personal information transmitted to the information provision destination device 3 by the information provision source device 2. For example, the recording price indicates the amount of recording price paid to the personal user.

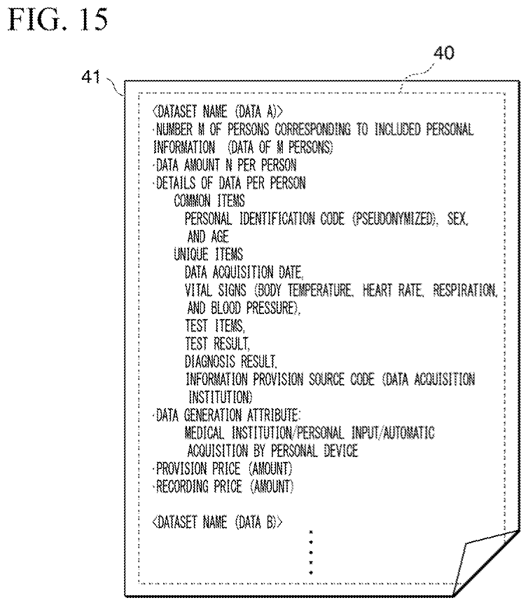

FIG. 15 is a diagram showing details of the web page for designating the dataset in the information transaction system including the information transaction device according to the fourth embodiment.

For example, the catalog information 40 in which the description items related to one or more datasets including the personal information are defined for each dataset is described on a dataset designation web page 41. As the description items related to the dataset, information such as the dataset name, the number M of persons corresponding to the personal information included in the dataset, the data amount N per person, the details of data (personal information) per person, the data generation attribute, the provision price, and the recording price is included in one piece of catalog information 40. For example, in a case where the provision source is a hospital, the details of the data per person include the common items (the personal identification code, the sex, and the age) and the unique items (the data acquisition date, the vital signs (the body temperature, the heart rate, the respiration, and the blood pressure), the test items, the test result, the diagnosis result, and the information provision source code). The information provision source code is identification information related to the organization of the information provision source managing the information provision source device. In addition, the data generation attribute includes identification information of a generation source of the personal information indicating whether the personal information is information registered by a medical institution (medical institution), information input by a person (personal input), or information automatically acquired from a device such as a sensor (automatic acquisition by a personal device). The responsible person of the organization of the information provision destination who uses the information provision destination device 3 selects the dataset of the provision request target by checking the catalog information 40 included in the dataset designation web page 41.

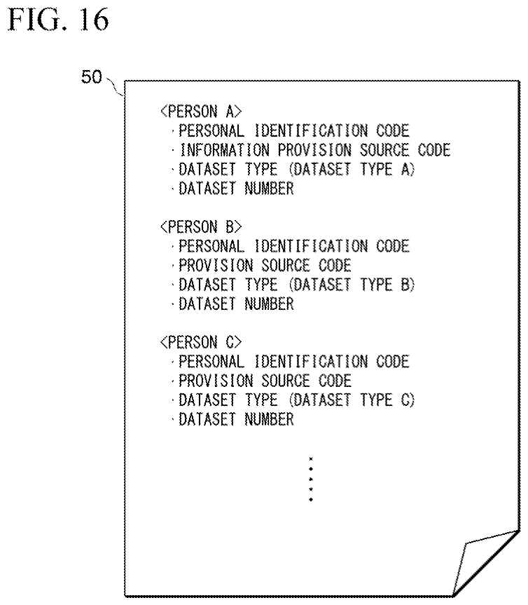

FIG. 16 is a diagram showing details of the personal data location information supplied in the information transaction system including the information transaction device according to the fourth embodiment.

The personal data location information 50 stores the personal identification code, the information provision source code, the dataset type, the dataset number, and the like for each person. The personal identification code is a code for identifying the personal user who provides the personal information. The information provision source code is identification information of the organization that manages the information provision source device 2 storing the dataset including the personal information of the person indicated by the personal identification code. The dataset type is information indicating the type of dataset including the personal information of the person indicated by the personal identification code. The dataset number is the number of datasets including the personal information of the person indicated by the personal identification code. For example, in a case where personal information of a certain person is included in each of 30 datasets, the number of datasets including the personal information of the person is 30. Based on the personal data location information, the information transaction device 1e specifies the information provision source device 2 storing the dataset indicated by the provision request acquired from the information provision destination device 3.

The information transaction system including the information transaction device 1e according to the fourth embodiment includes the information provision source device 2 and the information provision destination device 3 connected to the information transaction device 1e. The information transaction device 1e transmits, to the information provision destination device 3, the dataset designation web page 41 in which the description items related to one or more datasets including the personal information providable to the information provision destination device 3 from the information provision source device 2 are described for each dataset. The information transaction device 1e receives a selection of the dataset of the provision request target among one or more datasets described on the dataset designation web page from the information provision destination device 3. In a case where the information transaction device 1e receives approval of provision of the personal information included in the dataset of the provision request target, the information transaction device 1e outputs the transmission request for the personal information with respect to the information provision destination device 3 to the information provision source device 2 storing the personal information.

Accordingly, the personal information stored in the information provision source device 2 managed by each of the plurality of organizations of the information provision sources does not need to be stored in the information transaction device 1e. Thus, the personal information can be managed without concentrating a risk such as improper leakage of a large amount of personal information generated by each of the plurality of information provision sources managing the information provision source device 2 in the information transaction device 1e.

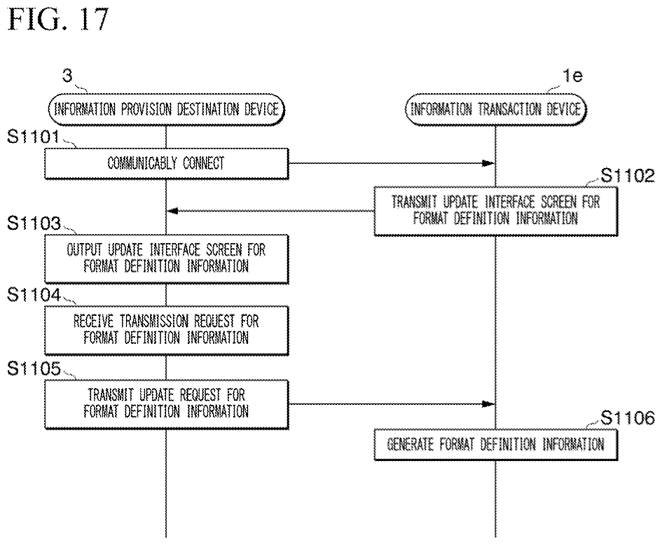

FIG. 17 shows a process flow performed between the information transaction device and the information provision destination device in the information transaction system including the information transaction device according to the fourth embodiment.

The information transaction device 1e further stores the format definition information in which a format type of the personal information included in the dataset is defined. The information provision source device 2 or the information provision destination device 3 can request the information transaction device 1e to generate the format definition information related to new personal information for which the format definition information stored in the information transaction device 1e is not defined yet.

In a case where the responsible person of the organization of the information provision destination desires to receive provision of a dataset including the new personal information, the responsible person connects the information provision destination device 3 to the information transaction device 1e. Accordingly, the information provision destination device 3 and the information transaction device 1e are connected (step S1101). The provision destination interface unit 14 of the information transaction device 1e has the function of the application programming interface (API) for updating the format definition information and transmits the update interface screen for the format definition information to the connected information provision destination device 3 (step S1102). The information provision destination device 3 acquires the update interface screen and outputs the update interface screen for the format definition information to the display (step S1103). The responsible person of the organization of the information provision destination inputs a format type of the personal information newly included in the dataset in an input field of the update interface screen for the format definition information and inputs the transmission request. The information provision destination device 3 receives the transmission request (step S1104). The information provision destination device 3 generates the update request for the format definition information including the input format type of the personal information and transmits the update request to the information transaction device 1e (step S1105).

The provision destination interface unit 14 of the information transaction device 1e acquires the update request for the format definition information. The provision destination interface unit 14 acquires the format type of the personal information newly included in the dataset from the update request for the format definition information and outputs the format type to the control unit 11. The control unit 11 generates the format definition information in which the format type of the personal information is defined, and records the format definition information in the storage unit of the information transaction device 1e (step S1106). By the above process, the information provision source device 2 can generate the dataset that includes the new personal information and for which the format definition information is not defined yet, using the format definition information in which the format type of the personal information is defined.

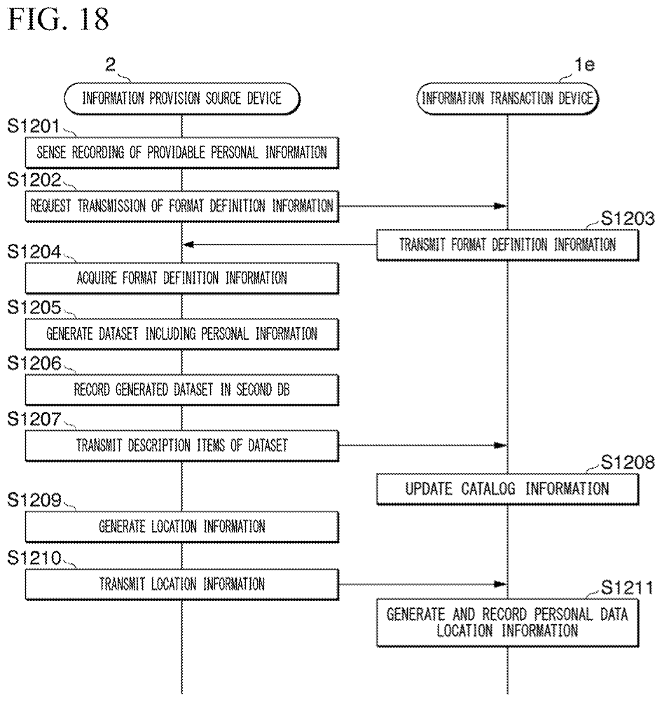

FIG. 18 shows a process flow performed between the information transaction device and the information provision source device in the information transaction system including the information transaction device according to the fourth embodiment.

The information provision source device 2 senses recording of providable personal information in the first DB 21 in generating the dataset including the personal information (step S1201). The personal information may be data including personal information generated by the computer of the organization of the information provision source connected to the information provision source device 2 or may be data including personal information automatically generated by a device such as a sensor. Alternatively, the dataset may be data including personal information that is input into the computer or the like belonging to the organization of the information provision source by the personal user, or may be data including personal information that is transmitted to the computer belonging to the organization of the information provision source by the personal user using the personal terminal 4.

The personal information may be information such as common items and unique items of the dataset designation web page 41. Here, for example, the common items may be the personal identification code, the sex, and the age of the person associated with the personal information included as the dataset. In addition, for example, the unique items may be the data acquisition date, the data content, and the identification information of the information provision source of the personal information included as the dataset. For example, in a case where the organization of the information provision source is a hospital, and a doctor of the hospital examines the personal user, the personal information included in the dataset generated in the hospital includes the personal identification code for identifying the person, the sex, the age, the data acquisition date, the vital signs, the test items in examination, the test result, and the diagnosis result. For example, the vital signs include the body temperature, the heart rate, the respiration, and the blood pressure.

The information provision source device 2 reads the personal information from the first DB 21. In generating the dataset including the personal information, the information provision source device 2 communicably connects to the information transaction device 1e and requests transmission of the format definition information (step S1202). The provision source interface unit 13 of the information transaction device 1e receives a designation of the personal information and transmits the format definition information corresponding to the personal information to the information provision source device 2 (step S1203). The format definition information is information in which the format of the personal information included in the dataset is defined.

The information provision source device 2 acquires the format definition information (step S1204). The information provision source device 2 generates the dataset including the personal information in accordance with the data type indicated by the format definition information (step S1205). The information provision source device 2 records the generated dataset in the second DB 22 (step S1206).

Accordingly, the information provision source device 2 stores the dataset holding the personal information in accordance with the data type indicated by the format definition information. The plurality of information provision source devices 2 generate datasets of the data type indicated by the format definition information in the same manner. Accordingly, the information provision destination device 3 that receives provision of the datasets can acquire uniform datasets of the same data type transmitted from each information provision source device 2. Thus, the information provision destination device 3 can easily perform a process using the personal information included in the datasets.

The information provision source device 2 specifies the description items of the generated dataset and transmits the description items of the dataset to the information transaction device 1e (step S1207). More specifically, the description items of the dataset include information such as the dataset name related to the dataset, the number M of persons corresponding to the personal information included in the dataset, the data amount N per person, the details of data (personal information) per person, the data generation attribute, the provision price, and the recording price. For example, in a case where the provision source is a hospital, the details of data per person include common items and unique items. Here, for example, the common items may be the personal identification code, the sex, and the age. In addition, for example, the unique items may be the data acquisition date, the vital signs (the body temperature, the heart rate, the respiration, and the blood pressure), the test items, the test result, the diagnosis result, and the information provision source code). The catalog information generation unit 15 of the information transaction device 1e acquires the description items of the dataset. The catalog information generation unit 15 generates new catalog information 40 obtained by further adding the catalog information 40 including the description items of the generated dataset to the past catalog information 40, and updates the already stored past catalog information 40 (step S1208). The catalog information 40 is information in which the description items related to one or more datasets are defined for each dataset that is a provision unit.

Based on the generated dataset, the information provision source device 2 generates the location information including the personal identification code of the person corresponding to the personal information included in the dataset, the information provision source code indicating the organization of the information provision source generating the dataset, the dataset type, the dataset number, and the like (step S1209). The information provision source device 2 transmits the location information to the information transaction device 1e (step S1210).

The provision source interface unit 13 of the information transaction device 1e acquires the location information transmitted from the information provision source device 2. The provision source interface unit 13 generates the personal data location information 50 including the new location information and records the personal data location information 50 in the database 104 of the information transaction device 1b (step S1211). Accordingly, the information transaction device 1e can perceive which information provision source device 2 holds which dataset.

The recording price calculation unit 19 may calculate the amount of recording price provided to the personal user corresponding to the personal information included in the dataset for recording of the dataset in the second DB 22. In this case, for example, the recording price calculation unit 19 specifies the dataset name recorded in the second DB 22. The recording price calculation unit 19 acquires the amount of recording price per unit amount of the dataset from the information transaction device 1e. The recording price calculation unit 19 calculates the amount of recording price of the dataset recorded in the second DB 22 based on the amount of recording price per unit amount of the dataset and transmits the calculated amount of recording price to the information transaction device 1e. The information transaction device 1e stores information about the amount of recording price of the dataset for each personal user. Based on a request from the personal terminal, the information transaction device 1e transmits the amount of recording price of the dataset stored for the personal user operating the personal terminal to the personal terminal 4. Accordingly, the personal user can check the price in a case where the personal information of the personal user is recorded in the information provision source device 2 as a provision candidate. The amount of recording price provided to the personal user may be calculated for each predetermined period.

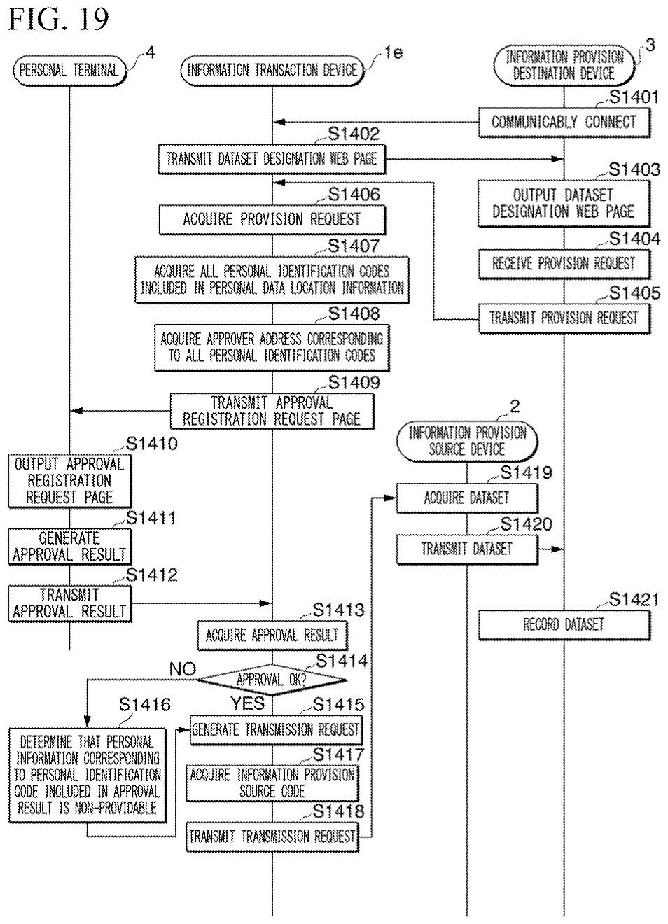

FIG. 19 shows a process flow performed among the information transaction device, the information provision destination device, the personal terminal, and the information provision source device in the information transaction system including the information transaction device according to the fourth embodiment.

In a case where the manager of the information provision destination such as the data application organization managing the information provision destination device 3 desires to receive provision of the dataset, the manager communicably connects the information provision destination device 3 to the information transaction device 1e. Accordingly, the information transaction device 1e and the information provision destination device 3 are communicably connected (step S1401). The provision destination interface unit 14 of the information transaction device 1e generates the dataset designation web page 41 on which the catalog information 40 is described. The catalog information 40 described on the dataset designation web page 41 includes the description items for each dataset of one or more datasets. Accordingly, the dataset designation web page 41 has a role as a catalog of datasets in which information about the description items of a plurality of datasets are included for each dataset. The provision destination interface unit 14 of the information transaction device 1e transmits the dataset designation web page 41 to the connected information provision destination device 3 (step S1402).

The information provision destination device 3 acquires the dataset designation web page 41 and outputs the dataset designation web page 41 to the display (step S1403). The responsible person of the organization of the information provision destination checks a check field of the catalog information 40 corresponding to a dataset requested to be provided among check fields displayed in association with each catalog information of the dataset designation web page 41, and presses the provision request button. The information provision destination device 3 receives the provision request (step S1404). The information provision destination device 3 specifies the dataset name included in one or a plurality of pieces of catalog information 40 received as the provision request and transmits the provision request including the dataset name to the information transaction device 1e (step S1405). In addition to the dataset name, the provision request may include information such as the ID of the information provision destination device 3 and the network address of the information provision destination device 3.

The provision destination interface unit 14 of the information transaction device 1e acquires the provision request (step S1406). The provision destination interface unit 14 outputs the provision request to the approver specifying unit 16. The approver specifying unit 16 acquires the provision request. The approver specifying unit 16 acquires the dataset name included in the provision request. The approver specifying unit 16 acquires all personal identification codes included in the personal data location information 50 in association with the dataset name (step S1407). The approver specifying unit 16 acquires the approver address that is stored in advance in the information transaction device 1e in association with all personal identification codes (step S1408). The approver address is the address of the personal terminal 4. Alternatively, the approver address may be an address held by an application program held by the personal terminal 4. The approver specifying unit 16 transmits the approval registration request page to each personal terminal 4 (approval request destination) specified by the approver address (step S1409). The approval registration request page includes information such as the dataset name included in the provision request and the organization name of the organization of the information provision destination managing the information provision destination device 3 that has transmitted the provision request.

Each personal terminal 4 acquires the approval registration request page. The personal terminal 4 outputs the approval registration request page to the display (step S1410). The approval registration request page may include the amount of provision price or recording price in association with the dataset name, and the approval registration request page including this information may be output to the display of the personal terminal 4. The personal user recognizes the dataset name, the organization name of the organization of the information provision destination, and the provision price or the recording price displayed on the approval registration request page and provides an approval input indicating whether or not the personal information specified by the dataset name may be provided to the organization of the information provision destination. For example, the buttons of approval OK and approval NG are further displayed on the approval registration request page. The user can provide the approval input indicating any of approval OK or approval NG by pressing any button using an input device such as a mouse. In a case where the user performs a press operation on the button of approval OK, each personal terminal 4 generates the approval result including the flag of approval OK (step S1411). In a case where the user performs a press operation on the button of approval NG, each personal terminal 4 generates the approval result including the flag of approval NG. The approval result may further include the dataset name, the organization name of the organization of the information provision destination, the personal identification code of the personal user using the personal terminal 4, and the like included in the approval request. Each personal terminal 4 transmits the generated approval result to the information transaction device 1e (step S1412).

The personal terminal interface unit 12 of the information transaction device 1e acquires the approval result received from each personal terminal 4 (step S1413). The personal terminal interface unit 12 outputs the approval result to the transmission request unit 17. The transmission request unit 17 determines whether or not the flag of approval OK is included in each approval result (step S1414). In a case where the flag of approval OK is included in each approval result, the transmission request unit 17 generates the transmission request (step S1415). The transmission request may include the dataset name, the organization name of the organization of the information provision destination, the ID of the information provision destination device 3, the network address of the information provision destination device 3, and the like included in the approval result. In a case where the flag of approval NG is included in each approval result, the transmission request unit 17 acquires the personal identification code included in the approval result and determines that the personal information corresponding to the personal identification code is non-providable (step S1416).

The transmission request unit 17 acquires the information provision source code for identifying one or each of the plurality of information provision source devices 2 included in the dataset designation web page 41 in association with the dataset name (step S1417). The transmission request unit 17 stores a network address of the information provision source device 2 in advance in association with the information provision source code. The transmission request unit 17 acquires the stored network address of the information provision source device 2 in association with the acquired information provision source code. The transmission request unit 17 transmits the transmission request to the acquired network address (step S1418). In the transmission request, the personal identification code included in the approval result indicating approval NG in step S1416 is stored as the personal identification code of the personal user corresponding to the non-providable personal information.

The information provision source device 2 receives the transmission request. The information provision source device 2 acquires the dataset name, the organization name of the organization of the provision destination, the ID of the information provision destination device 3, the network address of the information provision destination device 3, and the personal identification code of the personal user corresponding to the non-providable personal information included in the transmission request. The information provision source device 2 acquires the dataset corresponding to the dataset name from the second DB 22 (step S1419). The information provision source device 2 deletes the personal information corresponding to the personal identification code stored in the transmission request from the personal information included in the dataset. The information provision source device 2 transmits the dataset to the network address of the information provision destination device 3 included in the transmission request (step S1420). The information provision destination device 3 receives the dataset. The information provision destination device 3 records the received dataset in the database or the like included in the information provision destination device 3 (step S1421). Then, the information provision destination device 3 performs a predetermined process using the received dataset. The information provision source device 2 may transmit the dataset transmitted in accordance with the transmission request to the information provision destination device 3 through the information transaction device 1e. In a case of transferring to one information provision destination device 3, the information provision source device 2 may collectively transfer datasets acquired from a plurality of different information provision source devices 2.

According to the above process, the information transaction device 1e can control transmission of the dataset to the information provision destination device 3 desiring to receive provision without storing the dataset including the personal information generated by the plurality of information provision source devices 2 in the information transaction device 1e. Accordingly, a system for managing the personal information without concentrating a risk such as improper leakage of a large amount of personal information generated by each of the plurality of information provision sources managing the information provision source device 2 in the information transaction device 1e can be provided.

The provision price calculation unit 18 may calculate the amount of provision price provided to the personal user corresponding to the personal information included in the dataset for transmission of the dataset to the information provision destination device 3 from the information provision source device 2. In this case, for example, the provision price calculation unit 18 acquires information related to transmission of the dataset based on the transmission request from the information provision source device 2 and specifies the dataset name transmitted to the information provision destination device 3 by the information provision source device 2. The provision price calculation unit 18 acquires the amount of provision price per unit amount of the dataset from the information transaction device 1e. The provision price calculation unit 18 calculates the amount of provision price of the dataset transmitted to the information provision destination device 3 based on the amount of provision price per unit amount of the dataset and transmits the calculated amount of provision price to the information transaction device 1e. The information transaction device 1e stores information about the amount of provision price of the dataset for each personal user. Based on the request from the personal terminal, the information transaction device 1e transmits the amount of provision price of the dataset stored for the personal user operating the personal terminal to the personal terminal 4. Accordingly, the personal user can check the price for provision of the personal information of the personal user to the information provision destination device 3. The amount of provision price provided to the personal user may be calculated for each predetermined period.

### Fifth Embodiment

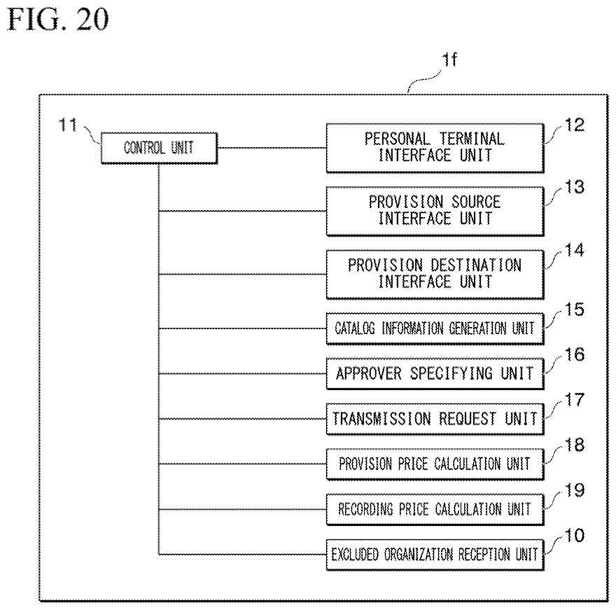

FIG. 20 is a function block diagram of an information transaction device according to a fifth embodiment.

An information transaction device if according to the fifth embodiment is different from the functions of the information transaction device 1e according to the fourth embodiment, in that the function of the excluded organization reception unit 10 is further exhibited.

The information transaction device if according to the fifth embodiment receives a selection of the organization of the exclusion target among the organizations managing the information provision destination device 3 from the personal user. Based on the dataset name indicated by the provision request transmitted by the information provision destination device 3, the information transaction device if specifies the personal data location information associated with the dataset name and acquires the personal identification code included in the personal data location information. In a case where the personal user corresponding to the personal identification code selects the organization associated with the information provision destination device 3 that has transmitted the provision request as the organization of the exclusion target, the information transaction device if stops at least one of the approval request for provision of the personal information to the personal user or transmission of the dataset including the personal information to the information provision destination device 3. Hereinafter, details of a process of an information transaction system including the information transaction device if of the fifth embodiment will be described.

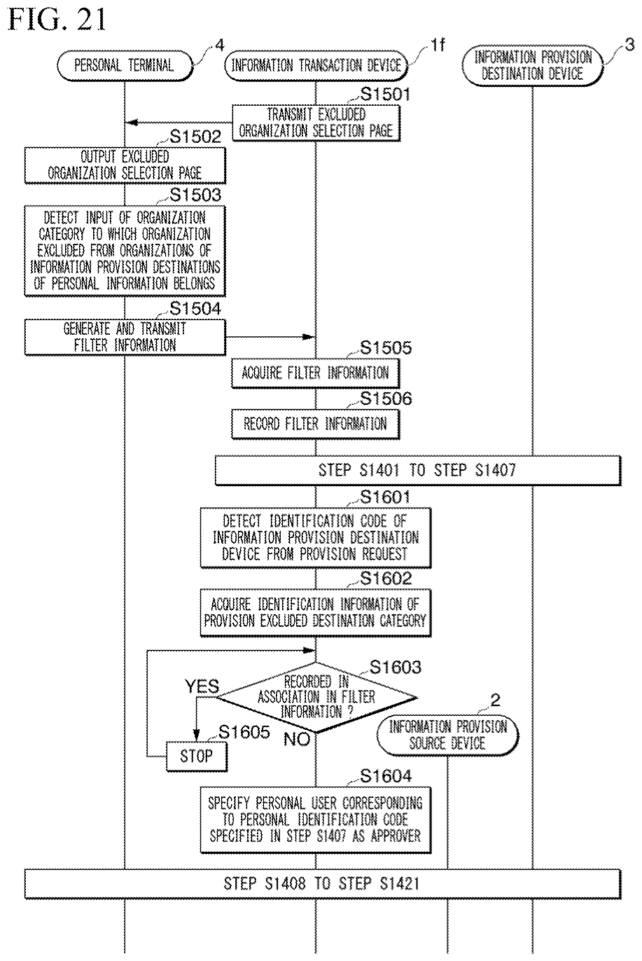

FIG. 21 is a diagram showing a process flow of the information transaction system including the information transaction device if according to the fifth embodiment.

In the process of receiving the selection of the organization excluded from the organizations as the information provision destinations of the dataset including the personal information of the personal user, the personal terminal interface unit 12 of the information transaction device if transmits the excluded organization selection page based on access from each personal terminal 4 (step S1501). Each personal terminal 4 outputs the excluded organization selection page to the display (step S1502). Each personal user selects the organization excluded from the provision destinations of the personal information on the excluded organization selection page displayed on the personal terminal 4. For example, a list of a plurality of organization categories to which candidates of the organization of the information provision destination of the personal information belong, and check buttons for designating exclusion of the organization categories are displayed on the excluded organization selection page. In addition, a registration button is displayed on the excluded organization selection page. Each personal user operates the check button of the organization category excluded from the organizations of the information provision destinations of the personal information to ON and performs a press operation on the registration button. Based on the operation, each personal terminal 4 detects an input of the organization category to which the organization excluded from the organizations of the information provision destinations of the personal information belongs (step S1503). Each personal terminal 4 generates the filter information including at least the personal identification code and the organization category to which the organization of the information provision destination of the exclusion target belongs, and transmits the filter information to the information transaction device if (step S1504).

The personal terminal interface unit 12 of the information transaction device if acquires the filter information from each personal terminal 4 (step S1505). The personal terminal interface unit 12 records each filter information in the storage unit such as the database 104 (step S1506). The filter information is information in which the personal identification code and the organization category (provision excluded destination category) of the organization that is selected to be excluded from the organizations of the information provision destinations by the personal user indicated by the personal identification code are associated with each other.

By the above process among a plurality of personal terminals 4, the filter information related to a plurality of personal users is recorded in the information transaction device 1f. It is assumed that the information transaction device if stores, in advance, the organization table in which the identification information of the organization category (provision excluded destination category), the identification code of the information provision source device 2 managing the organization belonging to the organization category, the network address of the information provision source device 2, and the like are held in association with each other.

In a state where the filter information and the organization table are stored as described above, processes of step S1401 to step S1405 of the fourth embodiment are performed, and the provision destination interface unit 14 of the information transaction device if acquires the provision request based on the process of step S1405 (step S1406). The provision destination interface unit 14 outputs the provision request to the approver specifying unit 16. The approver specifying unit 16 acquires the provision request. The approver specifying unit 16 acquires the dataset name included in the provision request. The approver specifying unit 16 acquires all personal identification codes included in the personal data location information 50 in association with the dataset name (step S1407). The process up to here is the same as in the fourth embodiment.

The approver specifying unit 16 detects, from the provision request, the identification code of the information provision destination device 3 that has transmitted the provision request acquired in step S1406 (step S1601). The approver specifying unit 16 acquires the identification information of the provision excluded destination category recorded in the organization table in association with the information provision destination device 3 (step S1602). The approver specifying unit 16 determines whether or not the personal user corresponding to the personal identification code specified in step S1407 excludes the organization associated with the information provision destination device 3 that has transmitted the provision request from the organizations of the information provision destinations. For example, the approver specifying unit 16 determines whether or not each personal identification code specified in step S1407 and the identification information of the provision excluded destination category acquired in step S1602 are recorded in the filter information in association with each other (step S1603). In a case where the personal identification code specified in step S1407 and the identification information of the provision excluded destination category acquired in step S1602 are not recorded in the filter information in association with each other, the approver specifying unit 16 specifies the personal user corresponding to the personal identification code specified in step S1407 as an approver (step S1604). In a case where the personal identification code specified in step S1407 and the identification information of the provision excluded destination category acquired in step S1602 are recorded in the filter information in association with each other, the approver specifying unit 16 stops the approval request for each personal user of each personal identification code specified in step S1407. Accordingly, the approver specifying unit 16 stops provision of the dataset including the personal information of the personal user (step S1605).

The subsequent process is the same as the process from step S1408 of the fourth embodiment. That is, the approver specifying unit 16 acquires the approver address stored in advance in the information transaction device if in association with the personal identification code specified in step S1407 as the approver (step S1408). The approver address is the address of the personal terminal 4. Alternatively, the approver address may be an address held by an application program held by the personal terminal 4. The approver specifying unit 16 transmits the approval registration request page to the personal terminal 4 specified by the approver address (step S1409). Then, based on approval of the personal user, the processes of step S1410 to step S1421 are performed in the same manner as in the fourth embodiment. However, in a process corresponding to step S1416 in the fifth embodiment, furthermore, the personal identification code of the personal user for which the approval request is stopped in step S1605 is acquired, and it is determined that the personal information corresponding to the personal identification code is non-providable.

According to the above process, in a case where the information transaction device if receives the provision request of the organization excluded from the organizations of the information provision destinations of the personal information, the information transaction device if does not make the approval request for provision of the dataset (personal information) indicated by the provision request to the personal terminal 4. Accordingly, by causing the personal user to register the organization excluded from the organizations of the information provision destinations of the personal information in advance, a system of the information transaction system that does not receive an unnecessary approval request related to information provision can be provided.

### Sixth Embodiment

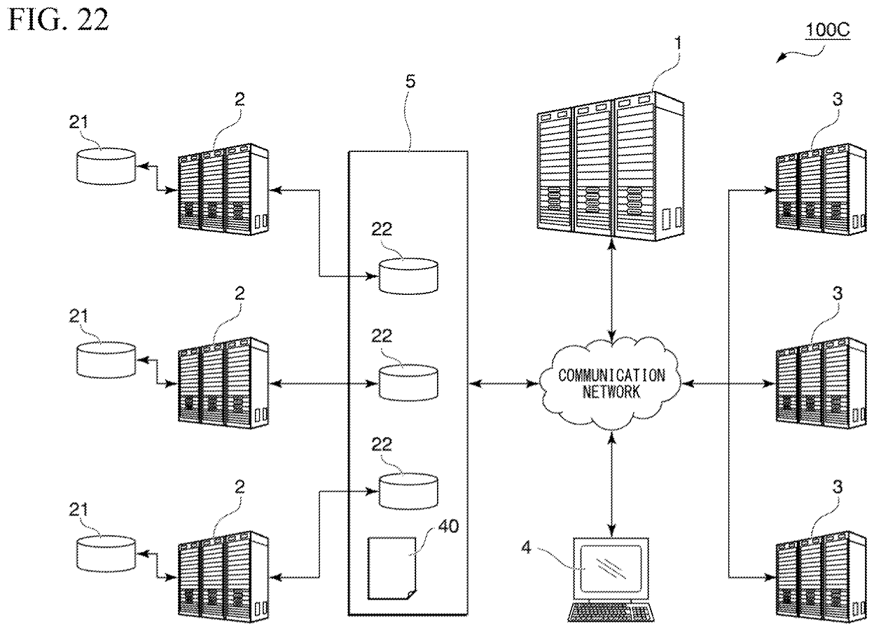

FIG. 22 is a diagram showing a configuration of an information transaction system according to a sixth embodiment.

An information transaction system 100C may have the configuration shown in FIG. 22. That is, in the information transaction system 100C, the data center 5 includes the second DB 22 included in the information provision source device 2 in the other embodiments. In addition, the data center 5 stores the catalog information 40 generated by the information transaction device 1. In a case where the information provision source device 2 generates the dataset, the information provision source device 2 registers the dataset in the second DB 22 included in the data center 5. In a case where the information transaction device 1 uses the catalog information 40, the information transaction device 1 may perform the process described in the other embodiments with reference to the catalog information 40 of the data center 5.

That is, in the information transaction device 1 of the information transaction system 100C according to the sixth embodiment, in a case where the description items of the dataset transmitted in step S1207 are acquired, the catalog information generation unit 15 generates new catalog information 40 obtained by further adding the catalog information 40 including the description items of the generated dataset to the past catalog information 40 acquired from the data center 5. In step S1208, the catalog information generation unit 15 updates the past catalog information 40 already stored in the data center 5.

In addition, in the information transaction device 1 of the information transaction system 100C according to the sixth embodiment, in step S1401, in a case where the information transaction device 1 and the information provision destination device 3 are communicably connected, the provision destination interface unit 14 of the information transaction device 1 acquires the catalog information 40 from the data center 5. The provision destination interface unit 14 generates the dataset designation web provision destination interface unit 14 transmits the dataset designation web page 41 to the connected information provision destination device 3.

In addition, in the information transaction device 1 of the information transaction system 100C according to the sixth embodiment, in step S1418, the transmission request unit 17 transmits the transmission request to the data center 5. In the transmission request, the personal identification code included in the approval result indicating approval NG in step S1416 is stored as the personal identification code of the personal user corresponding to the non-providable personal information. The data center 5 receives the transmission request. The data center 5 acquires the dataset name, the organization name of the organization of the provision destination, the ID of the information provision destination device 3, the network address of the information provision destination device 3, and the personal identification code of the personal user corresponding to the non-providable personal information included in the transmission request.

In addition, in the sixth embodiment, instead of the process of step S1419, the data center 5 acquires the dataset corresponding to the dataset name from the second DB 22. The data center 5 deletes the personal information corresponding to the personal identification code stored in the transmission request from the personal information included in the dataset. Instead of the process of step S1420, the data center 5 transmits the dataset to the network address of the information provision destination device 3 included in the transmission request. The data center 5 may store at least one of the dataset or the catalog information 40.

The embodiments of the present invention are described above. According to the process of each of the embodiments, an information transaction system in which a risk such as improper leakage of a large amount of personal information generated by each of the plurality of information provision sources managing the information provision source device 2 is not concentrated in the information transaction device 1 can be provided.

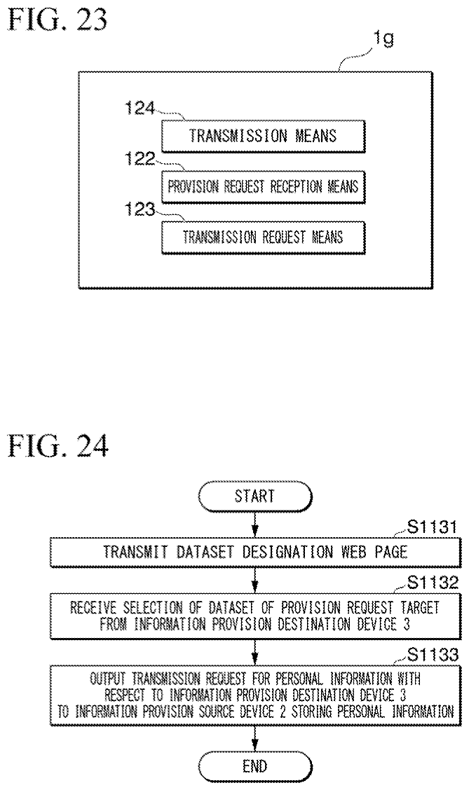

FIG. 23 is a diagram showing an information transaction device 1g of a minimum configuration included in the fourth to sixth embodiments.

FIG. 24 is a diagram showing a process performed by the information transaction device 1g of the minimum configuration included in the fourth to sixth embodiments.

The information transaction device 1g includes at least transmission means 124, the provision request reception means 122, and the transmission request means 123.

The transmission means 124 transmits, to the information provision destination device 3, the dataset designation web page 41 in which the description items related to one or more datasets including the personal information providable to the information provision destination device 3 from the information provision source device 2 are described for each dataset (step S1131).

The provision request reception means 122 receives a selection of the dataset of the provision request target among one or more datasets described on the dataset designation web page 41 from the information provision destination device 3 (step S1132).

In a case where the transmission request means 123 receives approval of provision of the personal information included in the dataset of the provision request target, the transmission request means 123 outputs the transmission request for the personal information with respect to the information provision destination device 3 to the information provision source device 2 storing the personal information (step S1133).

A computer system is included inside each of the above devices. A procedure of each of the above processes is stored in a computer-readable recording medium as a type of program, and the process is performed by causing the computer to read and execute the program. Here, the computer-readable recording medium refers to a magnetic disk, a magneto-optical disk, a CD-ROM, a DVD-ROM, a semiconductor memory, or the like. In addition, the computer program may be distributed to the computer using a communication line, and the computer receiving the distribution may execute the program.

In addition, the program may implement a part of the above functions. Furthermore, the program may be a so-called difference file (difference program) that can implement the above functions in combination with a program already recorded in the computer system.

Some or all of the embodiments may also be disclosed as, but not limited to, the following supplementary notes:

### (Supplementary Note 1)

An information transaction system including an information provision source device and an information transaction device connected to an information provision destination device, in which the information transaction device stores catalog information including detailed information related to one or more datasets including personal information providable to the information provision destination device from the information provision source device, receives a provision request for the dataset from the information provision destination device, and outputs a transmission request for the dataset indicated by the provision request with respect to the information provision destination device to the information provision source device.

### (Supplementary Note 2)

The information transaction system according to Supplementary Note 1, in which the information transaction device stores identification information of a personal user and location information indicating in which information provision source device a dataset including personal information of the personal user is recorded, acquires the identification information of the personal user included in the location information related to the dataset indicated by the provision request and makes an approval request for provision of the personal information to the personal user, and in a case where a result of the approval request indicates that the personal information is providable, outputs a transmission request for the dataset indicated by the provision request to the information provision source device.

### (Supplementary Note 3)

The information transaction system according to Supplementary Note 1 or 2, in which the information provision source device generates and stores the dataset including the personal information based on format definition information of the dataset.

### (Supplementary Note 4)

The information transaction system according to Supplementary Note 3, in which the information provision destination device transmits a request for adding new personal information other than personal information includable in the dataset indicated by the format definition information to the dataset, and the information provision source device generates the dataset using new format definition information generated based on the request for adding.

### (Supplementary Note 5)

The information transaction system according to Supplementary Note 2, in which the information transaction device receives a selection of an organization of an exclusion target among organizations managing the information provision destination device, acquires the identification information of the personal user included in the location information related to the dataset indicated by the provision request, and in a case where the personal user selects an organization associated with the information provision destination device that has transmitted the provision request as the organization of the exclusion target, stops at least one of the approval request for provision of the personal information to the personal user or transmission of the dataset including the personal information to the information provision destination device.

### (Supplementary Note 6)

The information transaction system according to any one of Appendices 1 to 5, in which a data center stores at least one of the dataset or the catalog information.

### (Supplementary Note 7)

An information transaction device configured to store catalog information including detailed information related to one or more datasets including personal information providable to an information provision destination device from an information provision source device, receive a provision request for the dataset from the information provision destination device, and output a transmission request for the dataset indicated by the provision request with respect to the information provision destination device to the information provision source device.

### (Supplementary Note 8)

An information transaction method in an information transaction system including an information transaction device communicably connected to an information provision source device and an information provision destination device, the information transaction method including, by the information transaction device, storing catalog information including detailed information related to one or more datasets including personal information providable to the information provision destination device from the information provision source device, receiving a provision request for the dataset from the information provision destination device, and outputting a transmission request for the dataset indicated by the provision request with respect to the information provision destination device to the information provision source device.

### (Supplementary Note 9)

A recording medium on which a program is recorded, the program causing a computer of an information transaction device to function as means for storing catalog information including detailed information related to one or more datasets including personal information providable to an information provision destination device from an information provision source device, means for receiving a provision request for the dataset from the information provision destination device, and means for outputting a transmission request for the dataset indicated by the provision request with respect to the information provision destination device to the information provision source device.

### (Supplementary Note 10)

An information transaction method including transmitting, to an information provision destination device, a dataset designation web page on which description items related to one or more datasets including personal information providable to the information provision destination device from an information provision source device are described for each dataset, receiving a selection of a dataset of a provision request target among the one or more datasets described on the dataset designation web page from the information provision destination device, and outputting, in a case where approval of provision of personal information included in the dataset of the provision request target is received, a transmission request for the personal information with respect to the information provision destination device to the information provision source device storing the personal information.

### (Supplementary Note 11)

The information transaction method according to Supplementary Note 10, further including storing identification information of a personal user and location information indicating in which information provision source device personal information of the personal user is recorded, and acquiring, from the location information, identification information of the personal user corresponding to personal information specified from the description items related to the dataset of the provision request target and making an approval request to an approval request destination corresponding to the identification information of the personal user.

### (Supplementary Note 12)

The information transaction method according to Supplementary Note 11, further including generating format definition information based on a designation of a format type of new personal information, and transmitting the format definition information to the information provision source device that generates the dataset including personal information corresponding to the format type indicated by the format definition information.

### (Supplementary Note 13)

The information transaction method according to Supplementary Note 11 or 12, further including receiving a selection of an organization of an exclusion target among organizations managing the information provision destination device, acquiring the identification information of the personal user included in the location information related to the dataset of the provision request target, and stopping, in a case where the personal user selects an organization associated with the information provision destination device receiving a selection of the dataset of the provision request target as the organization of the exclusion target, at least one of the approval request for provision of the personal information to the personal user or transmission of the dataset including the personal information to the information provision destination device.

### (Supplementary Note 14)

An information transaction device configured to transmit, to an information provision destination device, a dataset designation web page on which description items related to one or more datasets including personal information providable to the information provision destination device from an information provision source device are described for each dataset, receive a selection of a dataset of a provision request target among the one or more datasets described on the dataset designation web page from the information provision destination device, and in a case where approval of provision of personal information included in the dataset of the provision request target is received, output a transmission request for the personal information with respect to the information provision destination device to the information provision source device storing the personal information.

### (Supplementary Note 15)

A recording medium on which a program is recorded, the program causing a computer of an information transaction device to function as means for transmitting, to an information provision destination device, a dataset designation web page on which description items related to one or more datasets including personal information providable to the information provision destination device from an information provision source device are described for each dataset, means for receiving a selection of a dataset of a provision request target among the one or more datasets described on the dataset designation web page from the information provision destination device, and means for, in a case where approval of provision of personal information included in the dataset of the provision request target is received, outputting a transmission request for the personal information with respect to the information provision destination device to the information provision source device storing the personal information.

### (Supplementary Note 16)

The recording medium on which the program is recorded according to Supplementary Note 15, the program further causing the computer of the information transaction device storing identification information of a personal user and location information indicating in which information provision source device personal information of the personal user is recorded, to function as means for acquiring, from the location information, identification information of the personal user corresponding to personal information specified from the description items related to the dataset of the provision request target and making an approval request to an approval request destination with respect to the identification information of the personal user.

### (Supplementary Note 17)

The recording medium on which the program is recorded according to Supplementary Note 16, the program further causing the computer of the information transaction device to function as means for generating format definition information based on a designation of a format type of new personal information, and means for transmitting the format definition information to the information provision source device that generates the dataset including personal information corresponding to the format type indicated by the format definition information.

### (Supplementary Note 18)

The recording medium on which the program is recorded according to Supplementary Note 16, the program further causing the computer of the information transaction device to function as means for receiving a selection of an organization of an exclusion target among organizations managing the information provision destination device, means for acquiring the identification information of the personal user included in the location information related to the dataset of the provision request target, and means for, in a case where the personal user selects an organization associated with the information provision destination device receiving a selection of the dataset of the provision request target as the organization of the exclusion target, stopping at least one of the approval request for provision of the personal information to the personal user or transmission of the dataset including the personal information to the information provision destination device.

Priority is claimed on Japanese Patent Application No. 2019-199142, filed Oct. 31, 2019 and Japanese Patent Application No. 2020-29851, filed Feb. 25, 2020, the contents of which are incorporated herein by reference.

### INDUSTRIAL APPLICABILITY

According to the present invention, an information transaction system in which a risk such as improper leakage of a large amount of personal information generated by each of a plurality of information provision sources managing an information provision source device is not concentrated in an information transaction device can be provided.

### REFERENCE SYMBOLS

1, 1a, 1b, 1c, 1d, 1e, 1f: Information transaction device
2: Information provision source device
3: Information provision destination device
4: Personal terminal
5: Data center
10: Excluded organization reception unit
11: Control unit
12: Personal terminal interface unit
13: Provision source interface unit
14: Provision destination interface unit
15: Catalog information generation unit
16: Approver specifying unit
17: Transmission request unit
18: Provision price calculation unit
19: Recording price calculation unit
21: First DB
22: Second DB
100A, 100B, 100C: Information transaction system

What is claimed is:

1. An information transaction system comprising:
an information provision source device; and
an information transaction device connected to an information provision destination device,
wherein the information transaction device comprises:
a memory storing instructions; and
one or more processors connected to the memory and configured to execute the instructions to:
store catalog information including detailed information related to one or more datasets including personal information providable to the information provision destination device from the information provision source device;
receive a provision request for the dataset from the information provision destination device; and
output a transmission request for the dataset indicated by the provision request with respect to the information provision destination device to the information provision source device.

2. The information transaction system according to claim 1,
wherein the one or more processors included in the information transaction device are configured to further execute the instructions to:
store identification information of a personal user and location information indicating in which information provision source device a dataset including personal information of the personal user is recorded;
acquire the identification information of the personal user included in the location information related to the dataset indicated by the provision request and makes an approval request for provision of the personal information to the personal user; and
in a case where a result of the approval request indicates that the personal information is providable, output a transmission request for the dataset indicated by the provision request to the information provision source device.

3. The information transaction system according to claim 1,
wherein the information provision source device generates and stores the dataset including the personal information based on format definition information of the dataset.

4. The information transaction system according to claim 3,
wherein the information provision destination device transmits a request for adding new personal information other than personal information includable in the dataset indicated by the format definition information to the dataset, and
the information provision source device generates the dataset using new format definition information generated based on the request for adding.

5. The information transaction system according to claim 2,
wherein the one or more processors included in the information transaction device are configured to further execute the instructions to:
receive a selection of an organization of an exclusion target among organizations managing the information provision destination device;
acquire the identification information of the personal user included in the location information related to the dataset indicated by the provision request; and
in a case where the personal user selects an organization associated with the information provision destination device that has transmitted the provision request as the organization of the exclusion target, stop at least one of the approval request for provision of the personal information to the personal user or transmission of the dataset including the personal information to the information provision destination device.

6. The information transaction system according to claim 1,
wherein a data center stores at least one of the dataset or the catalog information.

7. An information transaction device comprising:
a memory storing instructions; and
one or more processors connected to the memory and configured to execute the instructions to:
store catalog information including detailed information related to one or more datasets including personal information providable to an information provision destination device from an information provision source device;
receive a provision request for the dataset from the information provision destination device; and
output a transmission request for the dataset indicated by the provision request with respect to the information provision destination device to the information provision source device.

8. An information transaction method in an information transaction system including an information transaction device communicably connected to an information provision source device and an information provision destination device, the information transaction method carried out by the information transaction device comprising:
storing catalog information including detailed information related to one or more datasets including personal information providable to the information provision destination device from the information provision source device;
receiving a provision request for the dataset from the information provision destination device; and
outputting a transmission request for the dataset indicated by the provision request with respect to the information provision destination device to the information provision source device.

9. A non-transitory computer readable recording medium on which a program is recorded, the program causing a computer of an information transaction device to execute:
storing catalog information including detailed information related to one or more datasets including personal information providable to an information provision destination device from an information provision source device;
receiving a provision request for the dataset from the information provision destination device; and
outputting a transmission request for the dataset indicated by the provision request with respect to the information provision destination device to the information provision source device.

10. An information transaction method comprising:
transmitting, to an information provision destination device, a dataset designation web page on which description items related to one or more datasets including personal information providable to the information provision destination device from an information provision source device are described for each dataset;
receiving a selection of a dataset of a provision request target among the one or more datasets described on the dataset designation web page from the information provision destination device; and
outputting, in a case where approval of provision of personal information included in the dataset of the provision request target is received, a transmission request for the personal information with respect to the information provision destination device to the information provision source device storing the personal information.

11. The information transaction method according to claim 10, further comprising:
storing identification information of a personal user and location information indicating in which information provision source device personal information of the personal user is recorded; and
acquiring, from the location information, identification information of the personal user corresponding to personal information specified from the description items related to the dataset of the provision request target and making an approval request to an approval request destination corresponding to the identification information of the personal user.

12. The information transaction method according to claim 11, further comprising:
generating format definition information based on a designation of a format type of new personal information; and
transmitting the format definition information to the information provision source device that generates the dataset including personal information corresponding to the format type indicated by the format definition information.

13. The information transaction method according to claim 11, further comprising:
receiving a selection of an organization of an exclusion target among organizations managing the information provision destination device;
acquiring the identification information of the personal user included in the location information related to the dataset of the provision request target; and
stopping, in a case where the personal user selects an organization associated with the information provision destination device receiving a selection of the dataset of the provision request target as the organization of the exclusion target, at least one of the approval request for provision of the personal information to the personal user or transmission of the dataset including the personal information to the information provision destination device.

14. An information transaction device comprising:
a memory storing instructions; and
one or more processors configured to execute the instructions to:
transmit, to an information provision destination device, a dataset designation web page on which description items related to one or more datasets including personal information providable to the information provision destination device from an information provision source device are described for each dataset;
receive a selection of a dataset of a provision request target among the one or more datasets described on the dataset designation web page from the information provision destination device; and
in a case where approval of provision of personal information included in the dataset of the provision request target is received, output a transmission request for the personal information with respect to the information provision destination device to the information provision source device storing the personal information.

15. A non-transitory computer readable recording medium on which a program is recorded, the program causing a computer of an information transaction device to execute:
transmitting, to an information provision destination device, a dataset designation web page on which description items related to one or more datasets including personal information providable to the information provision destination device from an information provision source device are described for each dataset;
receiving a selection of a dataset of a provision request target among the one or more datasets described on the dataset designation web page from the information provision destination device; and
in a case where approval of provision of personal information included in the dataset of the provision request target is received, outputting a transmission request for the personal information with respect to the information provision destination device to the information provision source device storing the personal information.

16. The non-transitory computer readable recording medium on which the program is recorded according to claim 15, the program further causing the computer of the information transaction device storing identification information of a personal user and location information indicating in which information provision source device personal information of the personal user is recorded, to execute:
acquiring, from the location information, identification information of the personal user corresponding to personal information specified from the description items related to the dataset of the provision request target and making an approval request to an approval request destination with respect to the identification information of the personal user.

17. The non-transitory computer readable recording medium on which the program is recorded according to claim 16, the program further causing the computer of the information transaction device to execute:
generating format definition information based on a designation of a format type of new personal information; and
transmitting the format definition information to the information provision source device that generates the dataset including personal information corresponding to the format type indicated by the format definition information.

18. The non-transitory computer readable recording medium on which the program is recorded according to claim 16, the program further causing the computer of the information transaction device to execute:
receiving a selection of an organization of an exclusion target among organizations managing the information provision destination device;
acquiring the identification information of the personal user included in the location information related to the dataset of the provision request target; and
in a case where the personal user selects an organization associated with the information provision destination device receiving a selection of the dataset of the provision request target as the organization of the exclusion target, stopping at least one of the approval request for provision of the personal information to the personal user or transmission of the dataset including the personal information to the information provision destination device.
